(19) United States
(12) Patent Application Publication
(10) Pub. No.: US 2022/0159201 A1
(43) Pub. Date: May 19, 2022

(54) EVENT DETECTION DEVICE, SYSTEM INCLUDING EVENT DETECTION DEVICE, AND EVENT DETECTION METHOD

(71) Applicant: Sony Semiconductor Solutions Corporation, Kanagawa (JP)

(72) Inventor: Shin Kitano, Kanagawa (JP)

(21) Appl. No.: 17/439,200

(22) PCT Filed: Apr. 20, 2020
(86) PCT No.: PCT/JP2020/017047

§ 371 Date: Sep. 14, 2021

(30) Foreign Application Priority Data
Apr. 26, 2019 (JP) 2019-085429

(51) Int. Cl. H04N 5/351; H04N 5/376; H04N 5/3745; H04N 5/343; G06V 20/50

(52) U.S. Cl. CPC H04N 5/351; H04N 5/3765; G06V 20/50; H04N 5/343; H04N 5/37452

(57) ABSTRACT

An event detection device includes a solid-state imaging element with photoelectric conversion elements each configured to perform photoelectric conversion on incident light to generate an electrical signal and an address event detection section configured to output a detection signal indicating a result of detection of whether or not an amount of change in the electrical signal of each of the plurality of photoelectric conversion elements exceeds a predetermined threshold. The event detection device also includes a timestamp signal generation section configured to generate a timestamp signal that is used for indicating a time point at which the address event detection section has detected the detection signal and a change section provided in the timestamp signal generation section and configured to change a temporal resolution of the timestamp signal in a case where a detection frequency of the address event detection signal exceeds a predetermined threshold.

### TECHNICAL FIELD

The present technology relates to an event detection device including an asynchronous solid-state imaging element, a system including the event detection device, and an event detection method.

### BACKGROUND ART

Hitherto, synchronous solid-state imaging elements configured to capture image data (frames) in synchronization with synchronization signals such as vertical synchronization signals have been used in imaging devices or the like. The general synchronous solid-state imaging elements can acquire image data only in every synchronization signal period (for example, 1/60 seconds), and thus have difficulty in meeting the demand for higher-speed processing in fields related to traffic, robots, and the like. Thus, there has been proposed an asynchronous solid-state imaging element including, for each pixel, a detection circuit configured to detect, at each pixel address, the fact that the amount of light of the pixel exceeds a threshold as an address event in real time (for example, see PTL 1). Solid-state imaging elements configured to detect address events for each pixel in this way are called DVS (Dynamic Vision Sensor).

### CITATION LIST

### Patent Literature

### [PTL 1]

JP-T-2017-535999

### SUMMARY

### Technical Problem

The asynchronous solid-state imaging element (that is, DVS) described above can generate and output data at a much higher speed than synchronous solid-state imaging elements. Thus, for example, in the traffic field, image recognition processing for humans or obstacles can be executed at high speed, so that a higher safety can be achieved. However, the recognition accuracy of the asynchronous solid-state imaging element varies depending on the moving speed of a moving object that is an imaging subject, which is a problem.

It is an object of the present technology to provide an event detection device that can enhance the imaging subject recognition accuracy of an asynchronous solid-state imaging element, a system including the event detection device, and an event detection method.

### Solution to Problem

According to the present technology, there is provided an event detection device including a solid-state imaging element. The solid-state imaging element includes a plurality of photoelectric conversion elements each configured to perform photoelectric conversion on incident light to generate an electrical signal and a detection section configured to output a detection signal indicating a result of detection of whether or not an amount of change in the electrical signal of each of the plurality of photoelectric conversion elements exceeds a predetermined threshold. The event detection device further includes a timestamp signal generation section configured to generate a timestamp signal that is used for indicating a time point at which the detection section has detected the detection signal and a change section provided in the timestamp signal generation section and configured to change a temporal resolution of the timestamp signal in a case where a predetermined condition is satisfied.

Further, according to the present technology, there is provided a system including a recognition processing section configured to recognize a predetermined object and an event detection device including a solid-state imaging element. The solid-state imaging element includes a plurality of photoelectric conversion elements each configured to perform photoelectric conversion on incident light to generate an electrical signal and a detection section configured to output a detection signal indicating a result of detection of whether or not an amount of change in the electrical signal of each of the plurality of photoelectric conversion elements exceeds a predetermined threshold. The event detection device further includes a timestamp signal generation section configured to generate a timestamp signal that is used for indicating a time point at which the detection section has detected the detection signal and a change section provided in the timestamp signal generation section and configured to change a temporal resolution of the timestamp signal in a case where a predetermined condition is satisfied. The event detection device determines that the predetermined condition is satisfied in a case where the recognition processing section has succeeded in object recognition.

Further, according to the present technology, there is provided an event detection method including performing, by a photoelectric conversion element, photoelectric conversion on incident light to generate an electrical signal; detecting, by a detection section, whether or not an amount of change in the electrical signal exceeds a predetermined threshold and outputting a detection signal; generating, by a timestamp signal generation section, a timestamp signal that is used for indicating a time point at which the detection signal has been detected; and changing, by a change section provided in the timestamp signal generation section, a temporal resolution of the timestamp signal in a case where a predetermined condition is satisfied.

### BRIEF DESCRIPTION OF DRAWINGS

FIG. 1 is a block diagram illustrating a configuration example of an imaging device according to a first embodiment of the present technology.

FIG. 2 is a diagram illustrating an exemplary stack structure of a solid-state imaging element according to the first embodiment of the present technology.

FIG. 3 is a block diagram illustrating a configuration example of the solid-state imaging element according to the first embodiment of the present technology.

FIG. 4 is a block diagram illustrating a configuration example of a pixel array section according to the first embodiment of the present technology.

FIG. 5 is a circuit diagram illustrating a configuration example of a pixel block according to the first embodiment of the present technology.

FIG. 6 is a block diagram illustrating a configuration example of an address event detection section according to the first embodiment of the present technology.

FIG. 7 is a circuit diagram illustrating a configuration example of a current-voltage conversion section according to the first embodiment of the present technology.

FIG. 8 is a circuit diagram illustrating configuration examples of subtractor and quantizer according to the first embodiment of the present technology.

FIG. 9 is a block diagram illustrating a configuration example of a column ADC (Analog-to-Digital Converter) according to the first embodiment of the present technology.

FIG. 10 is a timing chart illustrating exemplary operation of the solid-state imaging element according to the first embodiment of the present technology.

FIG. 11 is a flowchart illustrating exemplary operation of the solid-state imaging element according to the first embodiment of the present technology.

FIG. 12 is a circuit diagram illustrating a configuration example of a pixel block according to a first modified example of the first embodiment of the present technology.

FIG. 13 is a circuit diagram illustrating a configuration example of a pixel block according to a second modified example of the first embodiment of the present technology.

FIG. 14 is a circuit diagram illustrating a configuration example of a pixel block according to a third modified example of the first embodiment of the present technology.

FIG. 15 is a block diagram illustrating a configuration example of a pixel array section according to a second embodiment of the present technology.

FIG. 16 is a circuit diagram illustrating a configuration example of a light-receiving section according to the second embodiment of the present technology.

FIG. 17 is a circuit diagram illustrating a configuration example of the light-receiving section including no transfer transistor according to the second embodiment of the present technology.

FIG. 18 is a circuit diagram illustrating a configuration example of a current-voltage conversion section according to the second embodiment of the present technology.

FIG. 19 is a timing chart illustrating exemplary operation of a solid-state imaging element according to the second embodiment of the present technology.

FIG. 20 is a circuit diagram illustrating a configuration example of a current-voltage conversion section according to a modified example of the second embodiment of the present technology.

FIG. 21 is a circuit diagram illustrating a configuration example of an ADC according to the modified example of the second embodiment of the present technology.

FIG. 22 is a block diagram illustrating a configuration example of a pixel array section according to a third embodiment of the present technology.

FIG. 23 is a circuit diagram illustrating a configuration example of a light-receiving section according to the third embodiment of the present technology.

FIG. 24 is a block diagram illustrating a configuration example of an address event detection section according to the third embodiment of the present technology.

FIG. 25 is a circuit diagram illustrating a configuration example of a light-receiving section according to a modified example of the third embodiment of the present technology.

FIG. 26 is a block diagram illustrating a configuration example of a pixel array section according to a fourth embodiment of the present technology.

FIG. 27 is a block diagram illustrating a configuration example of a pixel array section according to a modified example of the fourth embodiment of the present technology.

FIG. 28 is a circuit diagram illustrating a configuration example of a normal pixel according to the modified example of the fourth embodiment of the present technology.

FIG. 29 is a block diagram illustrating a configuration example of a pixel array section according to a fifth embodiment of the present technology.

FIG. 30 is a block diagram illustrating a configuration example of a pixel block according to the fifth embodiment of the present technology.

FIG. 31 is a block diagram illustrating a configuration example of an event detection device according to a sixth embodiment of the present technology.

FIG. 32 is a block diagram illustrating a configuration example of a timestamp signal generation section according to the sixth embodiment of the present technology.

FIG. 33 is a block diagram illustrating a configuration example of a change section according to the sixth embodiment of the present technology.

FIG. 34 is a timing chart illustrating exemplary operation of the timestamp signal generation section according to the sixth embodiment of the present technology.

FIG. 35 is a flowchart illustrating exemplary operation of the event detection device according to the sixth embodiment of the present technology.

FIG. 36 is a flowchart illustrating exemplary operation of the timestamp signal generation section according to the sixth embodiment of the present technology.

FIG. 37 is a block diagram illustrating a configuration example of an event detection device according to a seventh embodiment of the present technology.

FIG. 38 is a block diagram illustrating a configuration example of a timestamp signal generation section according to the seventh embodiment of the present technology.

FIG. 39 is a block diagram illustrating a configuration example of a change section according to the seventh embodiment of the present technology.

FIG. 40 is a timing chart illustrating exemplary operation of the timestamp signal generation section according to the seventh embodiment of the present technology.

FIG. 41 is a flowchart illustrating exemplary operation of the timestamp signal generation section according to the seventh embodiment of the present technology.

FIG. 42 is a block diagram illustrating a configuration example of a timestamp signal generation section according to an eighth embodiment of the present technology.

FIG. 43 is a block diagram illustrating a configuration example of an object recognition system according to a ninth embodiment of the present technology.

FIG. 44 is a block diagram illustrating a configuration example of another object recognition system according to a tenth embodiment of the present technology.

FIG. 45 is a block diagram depicting an example of schematic configuration of a vehicle control system.

FIG. 46 is a diagram of assistance in explaining an example of installation positions of an outside-vehicle information detecting section and an imaging section.

### DESCRIPTION OF EMBODIMENTS

Now, modes for carrying out the present technology (hereinafter referred to as “embodiments”) are described. The following items are described in order.

1. First embodiment (an example in which a plurality of pixels shares an address event detection section)

2. Second embodiment (an example in which no pixel signal generation section is provided and the plurality of pixels shares the address event detection section)

3. Third embodiment (an example in which the plurality of pixels each including a capacitor shares the address event detection section)

4. Fourth embodiment (an example in which the address event detection section is disposed in each pixel)

5. Fifth embodiment (an example in which the number of pixels that share an image signal generation section is smaller than the number of pixels that share the address event detection section)

6. Sixth embodiment (an example in which a temporal resolution of a timestamp signal indicating a time point at which an address event has been detected is changed on the basis of an address event detection frequency)

7. Seventh embodiment (an example in which the temporal resolution of a timestamp signal indicating a time point at which an address event has been detected is changed on the basis of a change signal input from an external device)

8. Eighth embodiment (an example in which the temporal resolution of a timestamp signal indicating a time point at which an address event has been detected is changed on a pixel block column basis)

9. Ninth embodiment (an example in which the temporal resolution of a timestamp signal indicating a time point at which an address event has been detected is changed on the basis of a change signal input from a recognition processing section)

10. Tenth embodiment (another example in which the temporal resolution of a timestamp signal indicating a time point at which an address event has been detected is changed on the basis of a change signal input from the recognition processing section)

11. Application example to mobile body

### 1. First Embodiment

[Configuration Example of Imaging Device]

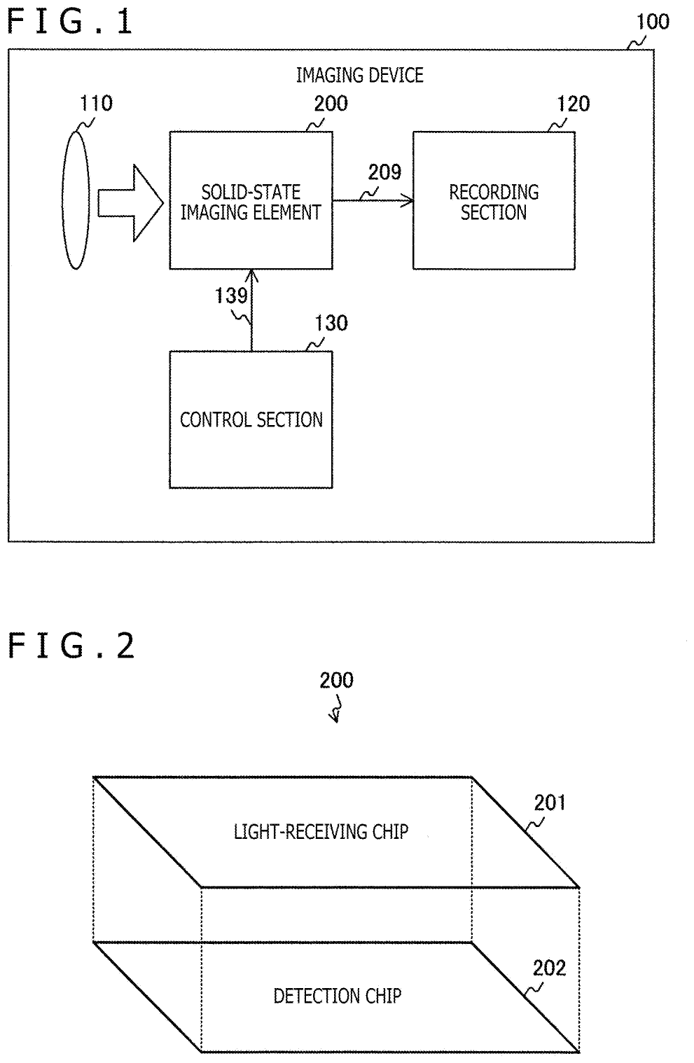

FIG. 1 is a block diagram illustrating a configuration example of an imaging device 100 according to a first embodiment of the present technology. The imaging device 100 includes an imaging lens 110, a solid-state imaging element 200, a recording section 120, and a control section 130. As the imaging device 100, a camera that is installed on an industrial robot, a vehicle-mounted camera, or the like is assumed.

The imaging lens 110 collects incident light and guides the incident light to the solid-state imaging element 200. The solid-state imaging element 200 performs photoelectric conversion on incident light to capture image data. The solid-state imaging element 200 executes, on the captured image data, predetermined signal processing such as image recognition processing and outputs data indicating the processing result and an address event detection signal to the recording section 120 through a signal line 209. A detection signal generation method is described later.

The recording section 120 records data from the solid-state imaging element 200. The control section 130 controls the solid-state imaging element 200 to capture image data.

[Configuration Example of Solid-State Imaging Element]

FIG. 2 is a diagram illustrating an exemplary stack structure of the solid-state imaging element 200 according to the first embodiment of the present technology. The solid-state imaging element 200 includes a detection chip 202 and a light-receiving chip 201 stacked on the detection chip 202. These chips are electrically connected to each other through connection portions such as vias. Note that the chips can also be connected to each other through Cu—Cu connection or bumps other than the vias.

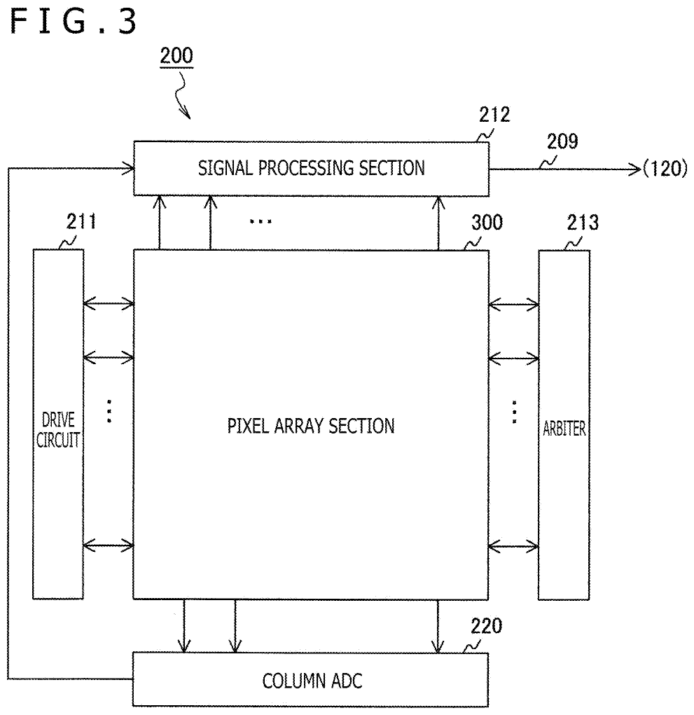

FIG. 3 is a block diagram illustrating a configuration example of the solid-state imaging element 200 according to the first embodiment of the present technology. The solid-state imaging element 200 includes a drive circuit 211, a signal processing section 212, an arbiter 213, a column ADC 220, and a pixel array section 300.

In the pixel array section 300, a plurality of pixels is arrayed in a two-dimensional lattice pattern. Further, the pixel array section 300 is divided into a plurality of pixel blocks each including a predetermined number of pixels. In the following, a collection of pixels or pixel blocks arrayed in a horizontal direction is referred to as a “row,” and a collection of pixels or pixel blocks arrayed in a direction vertical to the row is referred to as a “column.”

Each pixel generates an analog signal having a voltage based on a photocurrent as a pixel signal. Further, each pixel block detects presence or absence of an address event on the basis of whether or not an amount of change in photocurrent exceeds a predetermined threshold. Then, a pixel block in which an address event has occurred outputs a request to the arbiter.

The drive circuit 211 drives each pixel such that the pixels output pixel signals to the column ADC 220.

The arbiter 213 arbitrates between requests from the respective pixel blocks and transmits responses to the pixel blocks on the basis of the arbitration result. When receiving the response, the pixel block supplies a detection signal indicating a detection result to the drive circuit 211 and the signal processing section 212.

The column ADC 220 converts, for each column of the pixel blocks, analog pixel signals from the column to digital signals. The column ADC 220 supplies the digital signals to the signal processing section 212.

The signal processing section 212 executes, on a digital signal from the column ADC 220, predetermined signal processing such as CDS (Correlated Double Sampling) processing or image recognition processing. The signal processing section 212 supplies data indicating the processing result and a detection signal to the recording section 120 through the signal line 209.

[Configuration Example of Pixel Array Section]

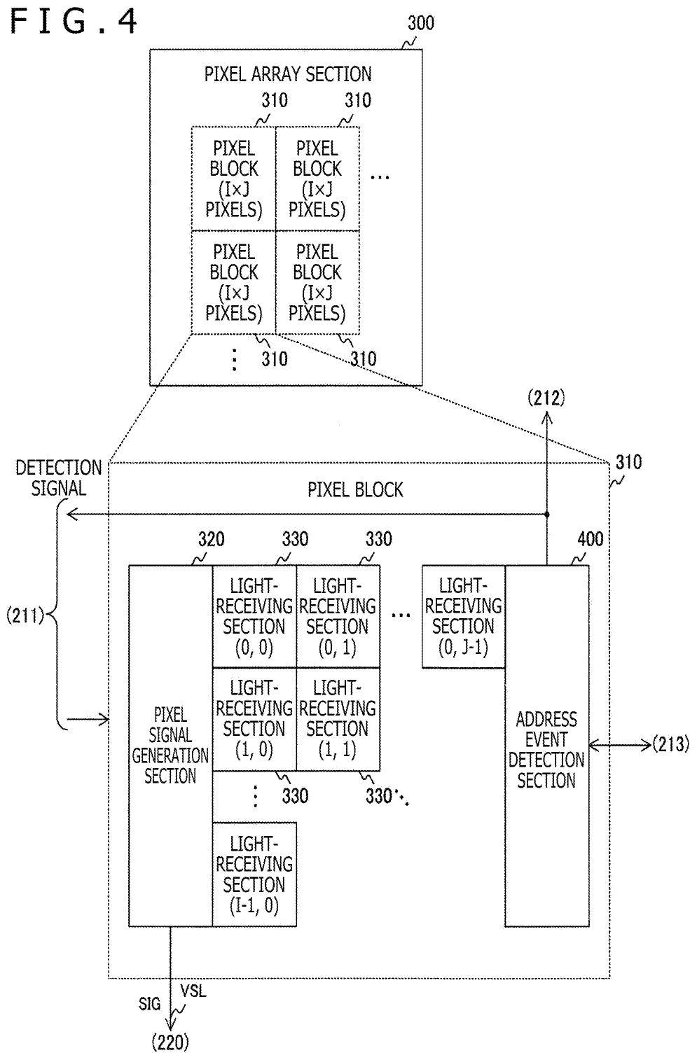

FIG. 4 is a block diagram illustrating a configuration example of the pixel array section 300 according to the first embodiment of the present technology. The pixel array section 300 is divided into a plurality of pixel blocks 310. In each of the pixel blocks 310, the plurality of pixels is arrayed in I rows and J columns (I and J are natural numbers).

Further, the pixel block 310 includes a pixel signal generation section 320, a plurality of light-receiving sections 330 in I rows and J columns, and an address event detection section 400. The plurality of light-receiving sections 330 in the pixel block 310 shares the pixel signal generation section 320 and the address event detection section 400. Further, a circuit including the light-receiving section 330 at certain coordinates, the pixel signal generation section 320, and the address event detection section 400 functions as a pixel at the coordinates in question. Further, a vertical signal line VSL is routed in each column of the pixel blocks 310. When the number of columns of the pixel blocks 310 is m (m is a natural number), the m vertical signal lines VSL are arrayed.

The light-receiving section 330 performs photoelectric conversion on incident light to generate a photocurrent. The light-receiving section 330 supplies, under the control of the drive circuit 211, the photocurrent to either one of the pixel signal generation section 320 and the address event detection section 400.

The pixel signal generation section 320 generates a signal having a voltage based on a photocurrent as a pixel signal SIG. The pixel signal generation section 320 supplies the generated pixel signal SIG to the column ADC 220 through the vertical signal line VSL.

The address event detection section 400 detects the presence or absence of an address event on the basis of whether or not the amount of change in photocurrent from each of the light-receiving sections 330 exceeds a predetermined threshold. Examples of this address event include on events indicating that the amount of change exceeds an upper limit threshold and off events indicating that the amount of change falls below a lower limit threshold. Further, examples of address event detection signals include 1 bit indicating on event detection results and 1 bit indicating off event detection results. Note that the address event detection section 400 can also detect only on events.

When an address event occurs, the address event detection section 400 supplies, to the arbiter 213, a request for requesting detection signal transmission. Then, when receiving a response to the request from the arbiter 213, the address event detection section 400 supplies a detection signal to the drive circuit 211 and the signal processing section 212. Note that the address event detection section 400 is an example of a detection section.

[Configuration Example of Pixel Block]

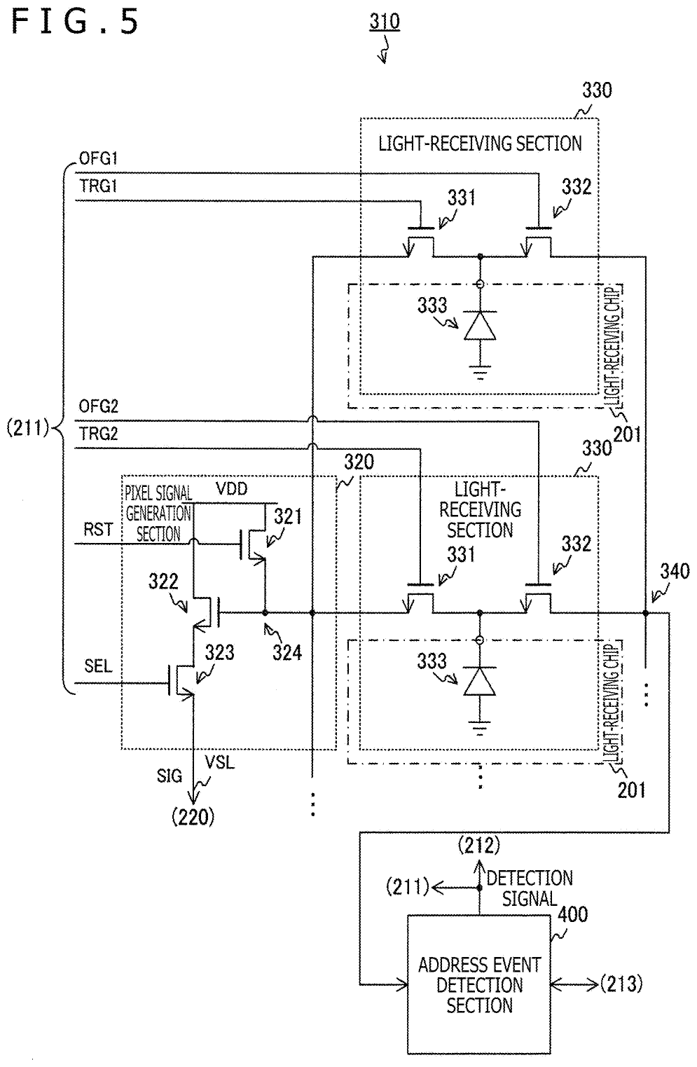

FIG. 5 is a circuit diagram illustrating a configuration example of the pixel block 310 according to the first embodiment of the present technology. In the pixel block 310, the pixel signal generation section 320 includes a reset transistor 321, an amplifier transistor 322, a select transistor 323, and a floating diffusion layer 324. The plurality of light-receiving sections 330 is connected to the address event detection section 400 in common through a connection node 340.

Further, the light-receiving sections 330 each include a transfer transistor 331, an OFG (Over Flow Gate) transistor 332, and a photoelectric conversion element 333. When the number of pixels in the pixel block 310 is N (N is a natural number), the N transfer transistors 331, the N OFG transistors 332, and the N photoelectric conversion elements 333 are disposed. The nth (n is a natural number of from 1 to N) transfer transistor 331 in the pixel block 310 receives a transfer signal TRGn supplied from the drive circuit 211. The nth OFG transistor 332 receives a control signal OFGn supplied from the drive circuit 211.

Further, as the reset transistor 321, the amplifier transistor 322, and the select transistor 323, for example, N-type MOS (Metal-Oxide-Semiconductor) transistors are used. As the transfer transistor 331 and the OFG transistor 332, N-type MOS transistors are also used.

Further, the photoelectric conversion elements 333 are each disposed on the light-receiving chip 201. All the elements other than the photoelectric conversion elements 333 are disposed on the detection chip 202.

The photoelectric conversion element 333 performs photoelectric conversion on incident light to generate charges. The transfer transistor 331 transfers, according to the transfer signal TRGn, charges from the corresponding photoelectric conversion element 333 to the floating diffusion layer 324. The OFG transistor 332 supplies, according to the control signal OFGn, an electrical signal generated by the corresponding photoelectric conversion element 333 to the connection node 340. Here, the electrical signal to be supplied is a photocurrent including charges. Note that a circuit including the transfer transistor 331 and the OFG transistor 332 of each pixel is an example of a signal supply section.

The floating diffusion layer 324 accumulates charges and generates a voltage based on an amount of the accumulated charges. The reset transistor 321 initializes the amount of charges in the floating diffusion layer 324 according to a reset signal from the drive circuit 211. The amplifier transistor 322 amplifies the voltage of the floating diffusion layer 324. The select transistor 323 outputs, according to a selection signal SEL from the drive circuit 211, a signal having an amplified voltage to the column ADC 220 as the pixel signal SIG through the vertical signal line VSL.

When being instructed to start address event detection by the control section 130, the drive circuit 211 drives the OFG transistor 332 of each pixel with the control signal OFGn, so that the OFG transistor 332 supplies a photocurrent. With this, a current corresponding to a sum of photocurrents of all the light-receiving sections 330 in the pixel block 310 is supplied to the address event detection section 400.

Further, when an address event is detected in a certain pixel block 310, the drive circuit 211 turns off all the OFG transistors 332 in the block in question to stop the supply of the photocurrents to the address event detection section 400. Then, the drive circuit 211 sequentially drives each of the transfer transistors 331 with the transfer signal TRGn, so that the transfer transistors 331 transfer the charges to the floating diffusion layer 324. With this, the pixel signals of the respective plurality of pixels in the pixel block 310 are sequentially output.

In this way, the solid-state imaging element 200 outputs, to the column ADC 220, only the pixel signals of the pixel block 310 in which an address event has been detected. With this, power consumption of the solid-state imaging element 200 and a processing amount of image processing can be reduced as compared to the case where the pixel signals of all pixels are output irrespective of the presence or absence of address events.

Further, the plurality of pixels shares the address event detection section 400, so that a circuit scale of the solid-state imaging element 200 can be reduced as compared to the case where the address event detection section 400 is disposed in each pixel.

[Configuration Example of Address Event Detection Section]

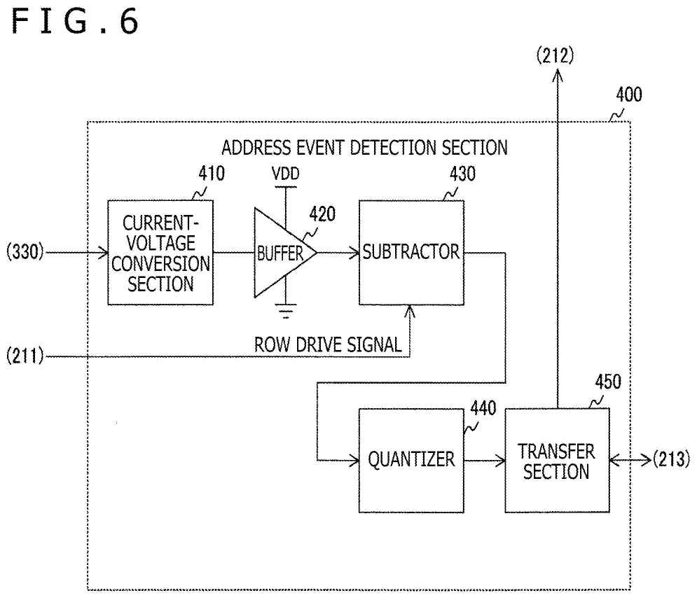

FIG. 6 is a block diagram illustrating a configuration example of the address event detection section 400 according to the first embodiment of the present technology. The address event detection section 400 includes a current-voltage conversion section 410, a buffer 420, a subtractor 430, a quantizer 440, and a transfer section 450.

The current-voltage conversion section 410 converts a photocurrent from the corresponding light-receiving section 330 to a voltage signal corresponding to a logarithm thereof. The current-voltage conversion section 410 supplies the voltage signal to the buffer 420.

The buffer 420 corrects a voltage signal from the current-voltage conversion section 410. The buffer 420 outputs the corrected voltage signal to the subtractor 430.

The subtractor 430 lowers, according to a row drive signal from the drive circuit 211, a level of a voltage signal from the buffer 420. The subtractor 430 supplies the voltage signal at the lowered level to the quantizer 440.

The quantizer 440 quantizes a voltage signal from the subtractor 430 to a digital signal and outputs the digital signal to the transfer section 450 as a detection signal.

The transfer section 450 transfers a detection signal from the quantizer 440 to the signal processing section 212 and the like. When an address event is detected, the transfer section 450 supplies, to the arbiter 213, a request for requesting detection signal transmission. Then, when receiving from the arbiter 213 a response to the request, the transfer section 450 supplies a detection signal to the drive circuit 211 and the signal processing section 212.

[Configuration Example of Current-Voltage Conversion Section]

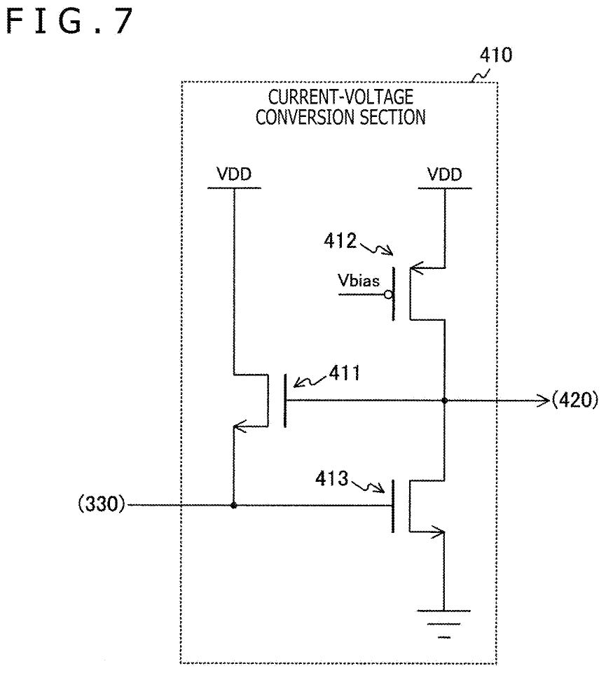

FIG. 7 is a circuit diagram illustrating a configuration example of the current-voltage conversion section 410 according to the first embodiment of the present technology. The current-voltage conversion section 410 includes N-type transistors 411 and 413 and a P-type transistor 412. As these transistors, for example, MOS transistors are used.

The N-type transistor 411 has a source connected to the light-receiving section 330 and a drain connected to a power supply terminal. The P-type transistor 412 is connected to the N-type transistor 413 in series between the power supply terminal and a ground terminal. Further, a node between the P-type transistor 412 and the N-type transistor 413 is connected to a gate of the N-type transistor 411 and an input terminal of the buffer 420. Further, a predetermined bias voltage Vbias is applied to a gate of the P-type transistor 412.

Drains of the N-type transistors 411 and 413 are connected on the power supply side. Such circuits are each called a “source follower.” The two connected source followers, which form a loop, convert a photocurrent from the light-receiving section 330 to a voltage signal corresponding to a logarithm thereof. Further, the P-type transistor 412 supplies a constant current to the N-type transistor 413.

[Configuration Examples of Subtractor and Quantizer]

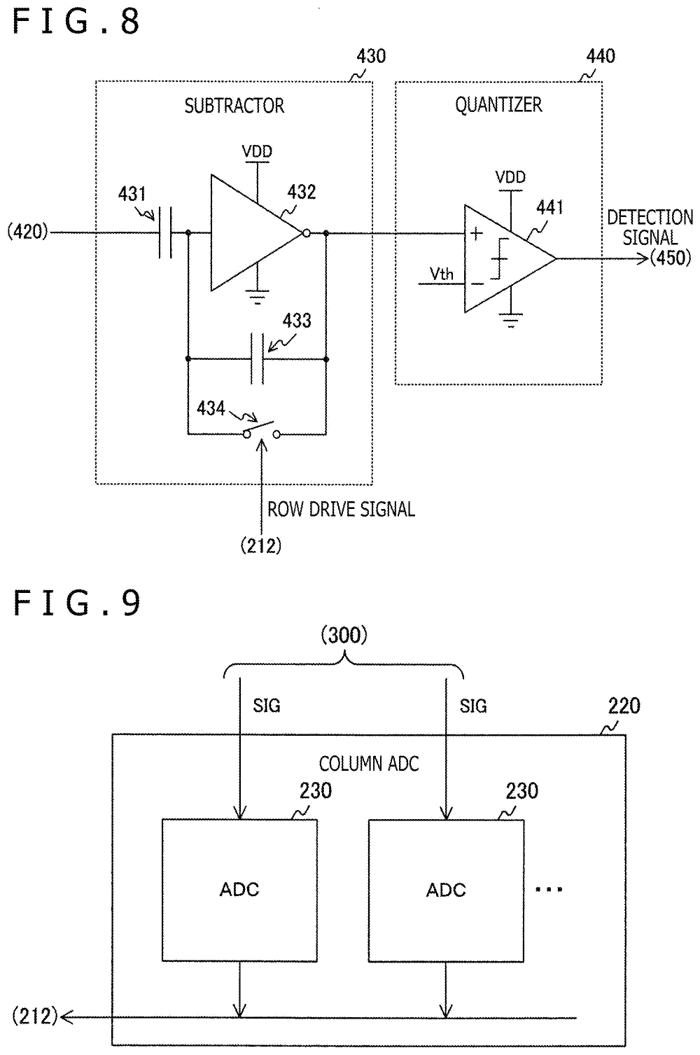

FIG. 8 is a circuit diagram illustrating configuration examples of the subtractor 430 and the quantizer 440 according to the first embodiment of the present technology. The subtractor 430 includes capacitors 431 and 433, an inverter 432, and a switch 434. Further, the quantizer 440 includes a comparator 441.

The capacitor 431 has one end connected to an output terminal of the buffer 420 and another end connected to an input terminal of the inverter 432. The capacitor 433 is connected to the inverter 432 in parallel. The switch 434 opens/closes a path connecting ends of the capacitor 433 to each other according to a row drive signal.

The inverter 432 inverts a voltage signal input through the capacitor 431. The inverter 432 outputs the inverted signal to a non-inverting input terminal (+) of the comparator 441.

When the switch 434 is turned on, a voltage signal Vinit is input on the buffer 420 side of the capacitor 431, and the other side of the capacitor 431 serves as a virtual ground terminal. A potential of this virtual ground terminal is regarded as zero as a matter of convenience. Here, a potential Qinit that is accumulated in the capacitor 431 is expressed by the following expression where C1 denotes a capacitance of the capacitor 431. Meanwhile, both of the ends of the capacitor 433 are short-circuited, so that no charge is accumulated in the capacitor 433.

Qinit=C1×Vinit Expression 1

Next, a case where the switch 434 is turned off and the voltage on the buffer 420 side of the capacitor 431 is changed to Vafter is considered. A charge Qafter that is accumulated in the capacitor 431 is expressed by the following expression.

Qafter=C1×Vafter Expression 2

Meanwhile, a charge Q2 that is accumulated in the capacitor 433 is expressed by the following expression where Vout denotes the output voltage.

Q2=−C2×Vout Expression 3

Here, since a total amount of charges in the capacitors 431 and 433 does not change, the following expression is established.

Qinit=Qafter+Q2 Expression 4

When Expression 1 to Expression 3 are substituted for Expression 4 to be transformed, the following expression is obtained.

Vout=−(C1/C2)×(Vafter−Vinit) Expression 5

Expression 5 expresses subtraction operation of a voltage signal, and a gain of the subtraction result is C1/C2. Since a maximum gain is desired in general, C1 is preferably set to a large value and C2 is preferably set to a small value. Meanwhile, when C2 is too small, kTC noise increases, resulting in a risk that noise characteristics deteriorate. Thus, the capacitance C2 can only be reduced in a range that achieves acceptable noise. Further, since each pixel block has installed thereon the address event detection section 400 including the subtractor 430, the capacitances C1 and C2 have space constraints. In consideration of these matters, values of the capacitances C1 and C2 are determined.

The comparator 441 compares a voltage signal from the subtractor 430 to a threshold voltage Vth applied to its inverting input terminal (−). The comparator 441 outputs a signal indicating the comparison result to the transfer section 450 as a detection signal.

Further, a gain A of the entire address event detection section 400 described above is expressed by the following expression where CGlog denotes a conversion gain of the current-voltage conversion section 410 and a gain of the buffer 420 is “1.”

$$\begin{matrix}[ Math . 1 ] & \\ A = \frac{{CG}_{log} \cdot C 1}{C 2} {\sum }_{n = 1}^{N} {i}_{photo} \_n & Expression 6\end{matrix}$$

In the above-mentioned expression, iphoto_n denotes a photocurrent of the nth pixel in units of ampere (A), for example. N denotes the number of pixels in the pixel block 310.

[Configuration Example of Column ADC]

FIG. 9 is a block diagram illustrating a configuration example of the column ADC 220 according to the first embodiment of the present technology. The column ADC 220 includes an ADC 230 in each column of the pixel blocks 310.

The ADC 230 converts the analog pixel signal SIG supplied through the vertical signal line VSL to a digital signal. The pixel signal SIG is converted to a digital signal greater in number of bits than a detection signal. For example, when a detection signal has 2 bits, a pixel signal is converted to a digital signal having 3 bits or more (for example, 16 bits). The ADC 230 supplies the generated digital signal to the signal processing section 212. Note that the ADC 230 is an example of an analog-to-digital converter.

[Operation Example of Solid-State Imaging Element]

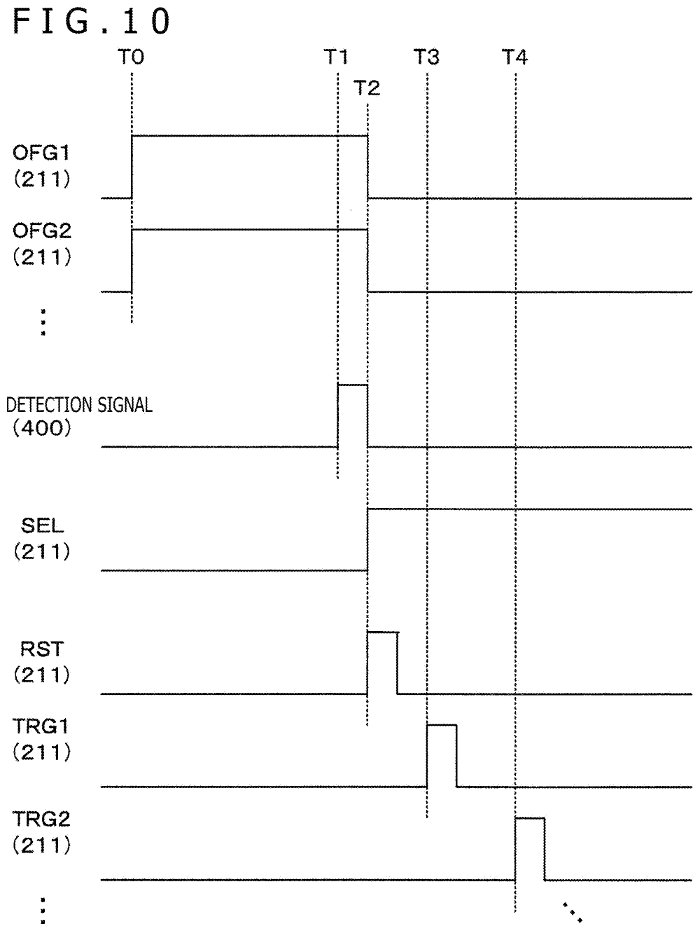

FIG. 10 is a timing chart illustrating exemplary operation of the solid-state imaging element 2000 according to the first embodiment of the present technology. When being instructed to start address event detection by the control section 130 at a timing T0, the drive circuit 211 sets all the control signals OFGn to a high level to turn on the OFG transistors 332 of all the pixels. With this, a sum of photocurrents of all the pixels is supplied to the address event detection section 400. Meanwhile, all the transfer signals TRGn are at a low level, and the transfer transistors 331 of all the pixels are thus in an off state.

Then, it is assumed that, at a timing T1, the address event detection section 400 detects an address event and outputs a detection signal at the high level. Here, the detection signal is assumed to be a 1-bit signal indicating that an on event has been detected.

When receiving the detection signal, at a timing T2, the drive circuit 211 sets all the control signals OFGn to a low level to stop the supply of the photocurrents to the address event detection section 400. Further, the drive circuit 211 sets the selection signal SEL to a high level and sets the reset signal RST to a high level over a certain pulse period, thereby initializing the floating diffusion layer 324. The pixel signal generation section 320 outputs the voltage in the initialization as a reset level, and the ADC 230 converts the reset level to a digital signal.

At a timing T3 after the reset level conversion, the drive circuit 211 supplies a transfer signal TRG1 at a high level over a certain pulse period to control the first pixel to output the voltage as a signal level. The ADC 230 converts the signal level to a digital signal. The signal processing section 212 obtains a difference between the reset level and the signal level as a net pixel signal. This processing is called CDS processing.

At a timing T4 after the signal level conversion, the drive circuit 211 supplies a transfer signal TRG2 at a high level over a certain pulse period to control the second pixel to output the signal level. The signal processing section 212 obtains a difference between the reset level and the signal level as a net pixel signal. Similar processing is executed thereafter, so that the pixel signals of the respective pixels in the pixel block 310 are sequentially output.

When all the pixel signals are output, the drive circuit 211 sets all the control signals OFGn to the high level to turn on the OFG transistors 332 of all the pixels.

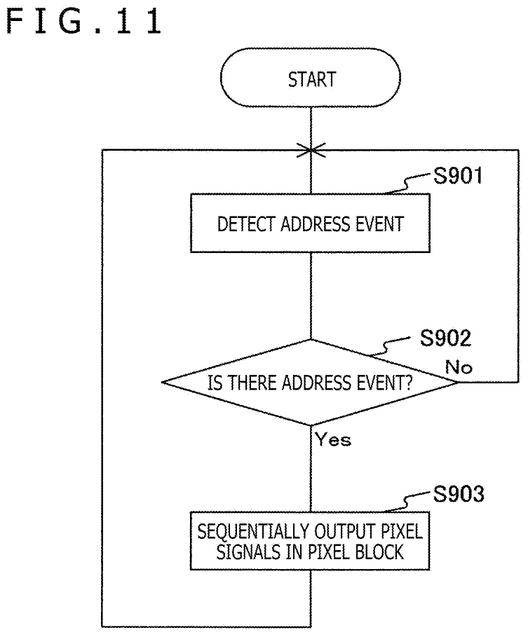

FIG. 11 is a flowchart illustrating exemplary operation of the solid-state imaging element 200 according to the first embodiment of the present technology. This operation starts when a predetermined application for address event detection is executed, for example.

The pixel blocks 310 each detect the presence or absence of an address event (Step S901). The drive circuit 211 determines whether or not there is an address event in any of the pixel blocks 310 (Step S902). In a case where there is an address event (Step S902: Yes), the drive circuit 211 makes the pixels in the pixel block 310 in which the address event has occurred sequentially output the pixel signals (Step S903).

In a case where there is no address event (Step S902: No) or after Step S903, the solid-state imaging element 200 repeats Step S901 and the following steps.

In this way, according to the first embodiment of the present technology, the address event detection section 400 detects the amount of change in photocurrent of each of the plurality of (N) photoelectric conversion elements 333 (pixels), so that disposing a single address event detection section 400 for every N pixels is sufficient. The N pixels share the single address event detection section 400 in this way, so that the circuit scale can be reduced as compared to the configuration in which the address event detection section 400 is not shared and provided for each pixel.

### First Modified Example

In the first embodiment described above, the elements other than the photoelectric conversion element 333 are disposed on the detection chip 202, but this configuration has a risk that, as the number of pixels is increased, the circuit scale of the detection chip 202 is increased. The solid-state imaging element 200 according to a first modified example of the first embodiment is different from the first embodiment in that the detection chip 202 has a reduced circuit scale.

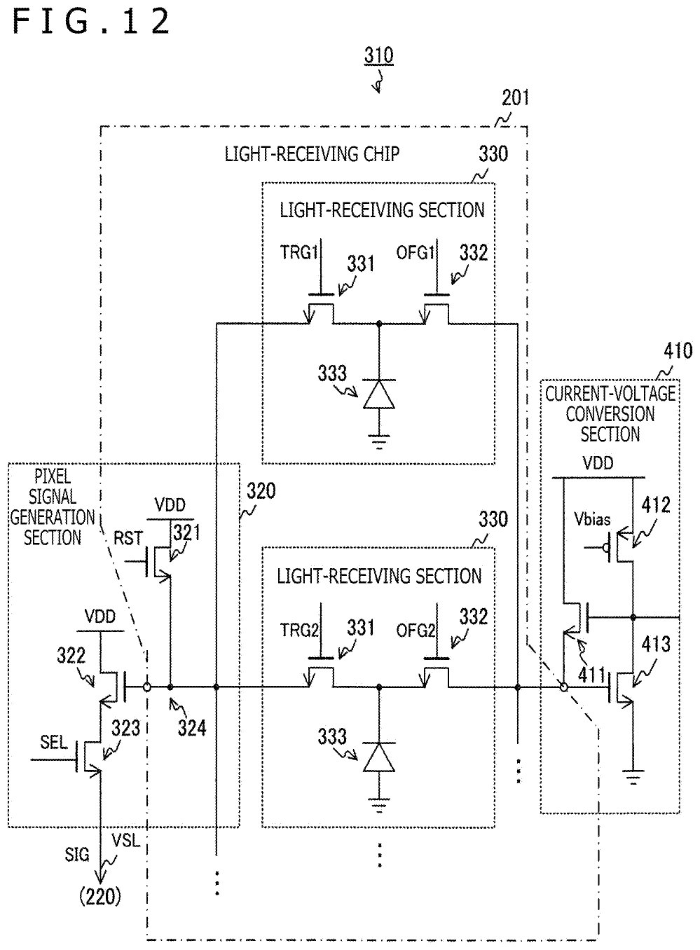

FIG. 12 is a circuit diagram illustrating a configuration example of the pixel block 310 according to the first modified example of the first embodiment of the present technology. The pixel block 310 according to the first modified example of the first embodiment is different from the first embodiment in that the reset transistor 321, the floating diffusion layer 324, and the plurality of light-receiving sections 330 are disposed on the light-receiving chip 201. The remaining elements are disposed on the detection chip 202.

In this way, according to the first modified example of the first embodiment of the present technology, the reset transistor 321 and the like and the plurality of light-receiving sections 330 are disposed on the light-receiving chip 201, so that the circuit scale of the detection chip 202 can be reduced as compared to the first embodiment.

### Second Modified Example

In the first modified example of the first embodiment described above, the reset transistor 321 and the like and the plurality of light-receiving sections 330 are disposed on the light-receiving chip 201, but this configuration has a risk that, as the number of pixels is increased, the circuit scale of the detection chip 202 is increased. The solid-state imaging element 200 according to a second modified example of the first embodiment is different from the first modified example of the first embodiment in that the detection chip 202 has a further reduced circuit scale.

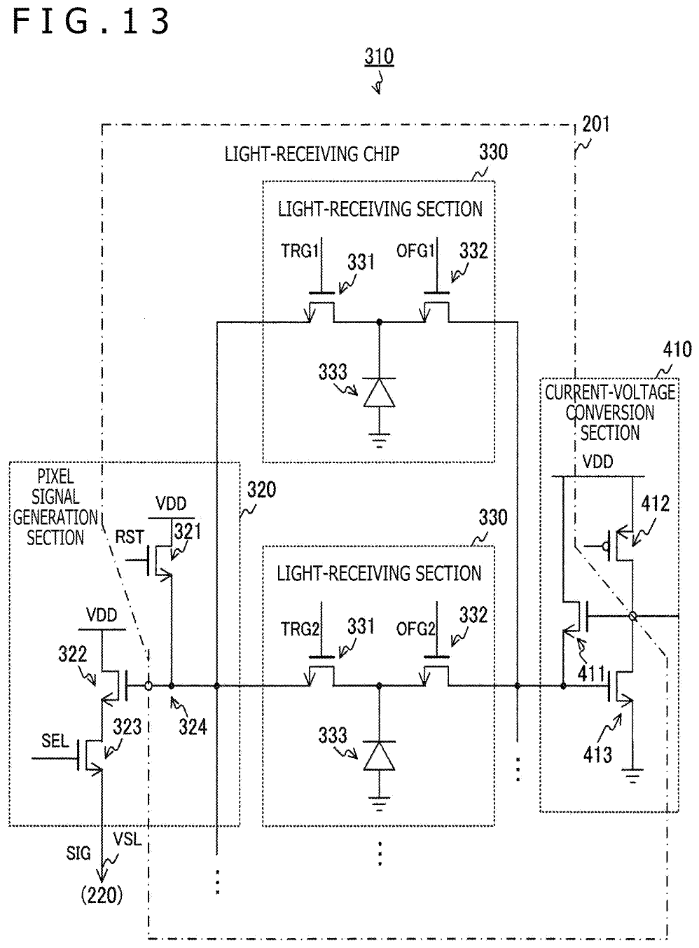

FIG. 13 is a circuit diagram illustrating a configuration example of the pixel block 310 according to the second modified example of the first embodiment of the present technology. The pixel block 310 according to the second modified example of the first embodiment is different from the first modified example of the first embodiment in that the N-type transistors 411 and 413 are also disposed on the light-receiving chip 201. In this way, only the N-type transistors are provided on the light-receiving chip 201, so that the number of processes for forming the transistors can be reduced as compared to the case where both N-type transistors and P-type transistors are provided on the light-receiving chip 201. With this, manufacturing cost of the light-receiving chip 201 can be reduced.

In this way, according to the second modified example of the first embodiment of the present technology, the N-type transistors 411 and 413 are also disposed on the light-receiving chip 201, so that the circuit scale of the detection chip 202 can be reduced as compared to the first modified example of the first embodiment.

### Third Modified Example

In the second modified example of the first embodiment described above, the N-type transistors 411 and 413 are also disposed on the light-receiving chip 201, but this configuration has a risk that, as the number of pixels is increased, the circuit scale of the detection chip 202 is increased. The solid-state imaging element 200 according to a third modified example of the first embodiment is different from the second modified example of the first embodiment in that the detection chip 202 has a further reduced circuit scale.

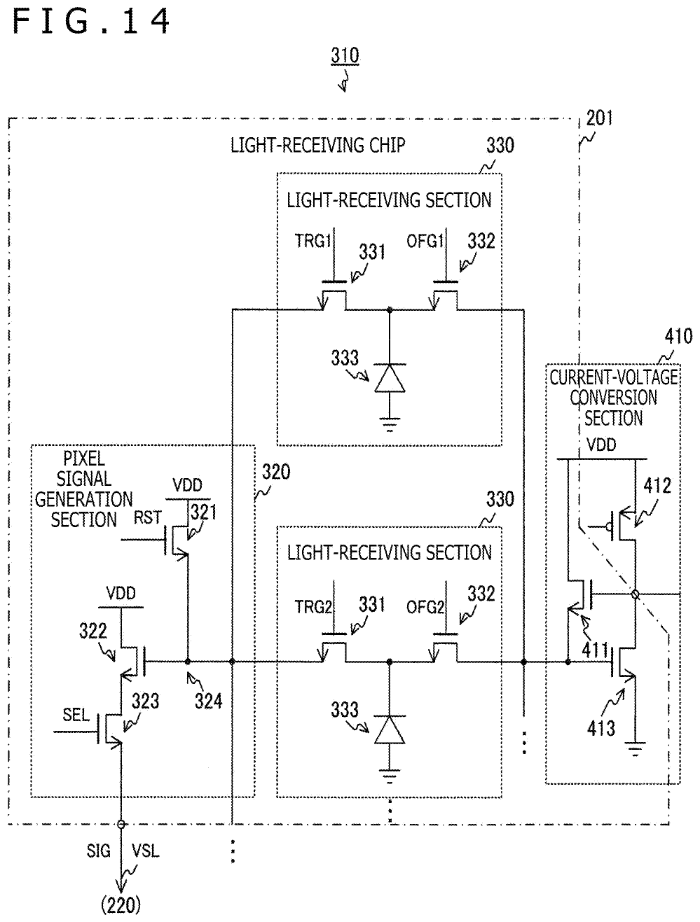

FIG. 14 is a circuit diagram illustrating a configuration example of the pixel block 310 according to the third modified example of the first embodiment of the present technology. The pixel block 310 according to the third modified example of the first embodiment is different from the second modified example of the first embodiment in that the amplifier transistor 322 and the select transistor 323 are also disposed on the light-receiving chip 201. That is, all the elements of the pixel signal generation section 320 are disposed on the light-receiving chip 201.

In this way, according to the third modified example of the first embodiment of the present technology, the pixel signal generation section 320 is disposed on the light-receiving chip 201, so that the circuit scale of the detection chip 202 can be reduced as compared to the second modified example of the first embodiment.

### 2. Second Embodiment

In the first embodiment described above, the pixel signal generation section 320 is provided for each of the pixel blocks 310, but this configuration has a risk that, as the number of pixels is increased, the circuit scale of the solid-state imaging element 200 is increased. The solid-state imaging element 200 of a second embodiment is different from the first embodiment in that the pixel signal generation section 320 is removed.

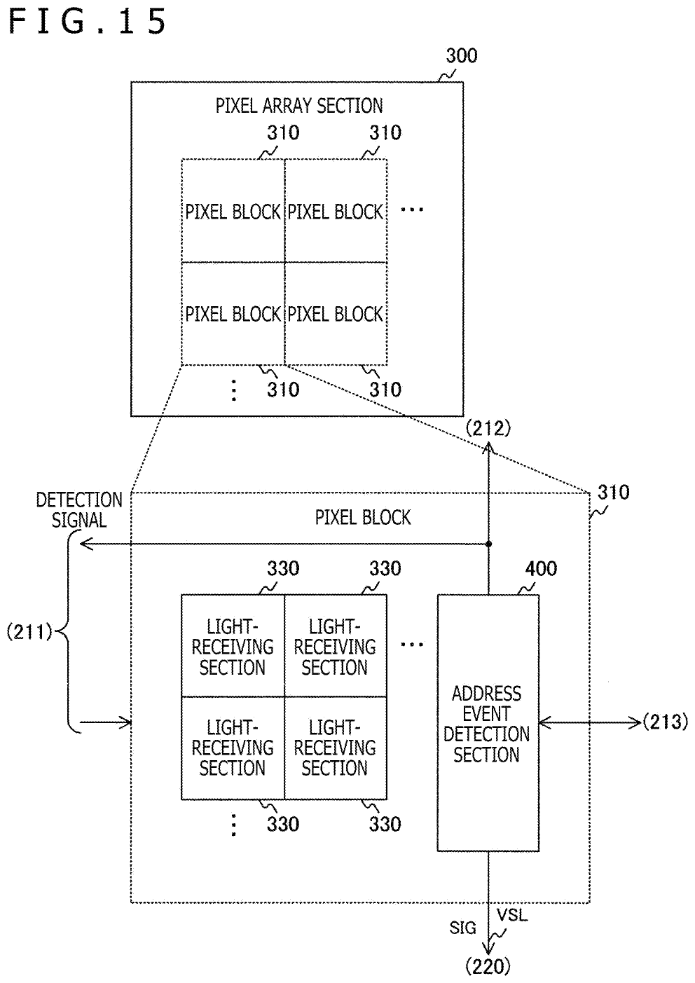

FIG. 15 is a block diagram illustrating a configuration example of the pixel array section 300 according to the second embodiment of the present technology. The pixel array section 300 is different from the first embodiment in not including the pixel signal generation section 320.

Further, the address event detection section 400 of the second embodiment is different from the first embodiment in generating the pixel signal SIG and outputting the pixel signal SIG through the vertical signal line VSL.

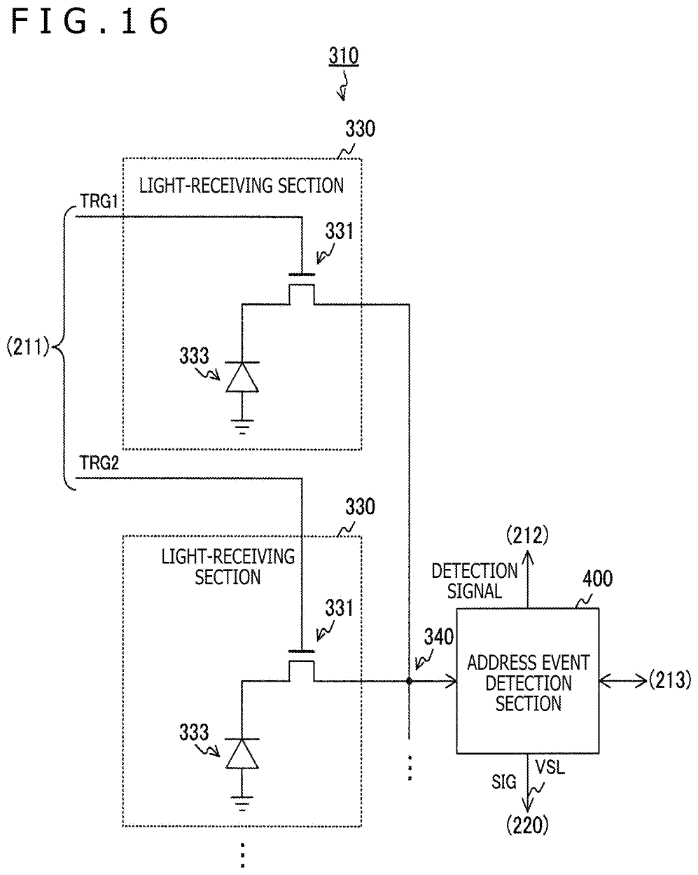

FIG. 16 is a circuit diagram illustrating a configuration example of the light-receiving section 330 according to the second embodiment of the present technology. The light-receiving section 330 of the second embodiment is different from the first embodiment in not including the OFG transistor 332.

Further, the transfer transistor 331 of the second embodiment supplies a photocurrent from the photoelectric conversion element 333 to the address event detection section 400 through the connection node 340.

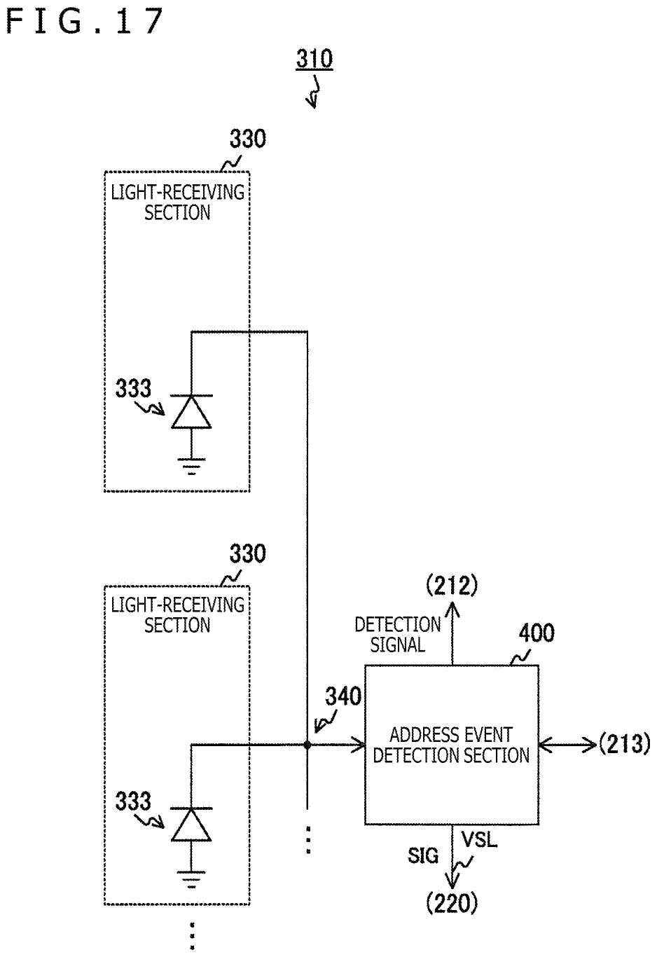

Note that the light-receiving sections 330, each of which includes the transfer transistor 331, may not include the transistor in question as exemplified in FIG. 17. In this case, there is no need for the drive circuit 211 to supply the transfer signal TRGn to the light-receiving section 330.

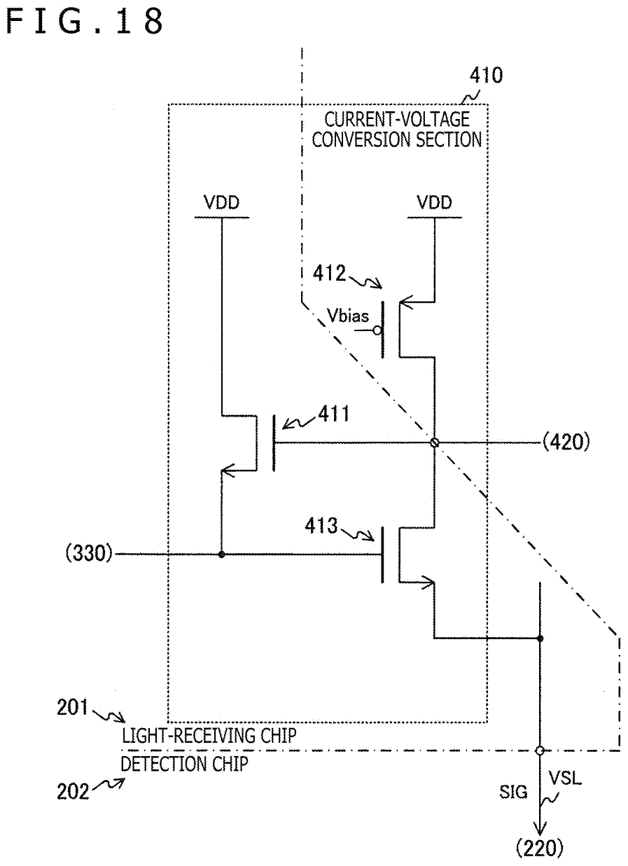

FIG. 18 is a circuit diagram illustrating a configuration example of the current-voltage conversion section 410 according to the second embodiment of the present technology. The current-voltage conversion section 410 of the second embodiment is different from the first embodiment in that a source of the N-type transistor 413 is connected to the vertical signal line VSL.

Further, when an address event is detected, the drive circuit 211 lowers the voltage (Vbias), which is applied to the gate of the P-type transistor 412, to a low level lower than a before-detection level. With this, the gate of the N-type transistor 411 has a voltage that is a power supply voltage VDD as the drain thereof, so that the N-type transistor 411 is put into a state equivalent to the case of being diode-connected. Further, the pixel signal SIG at a voltage corresponding to the photocurrent is generated by the N-type transistor 413 that serves as a source follower.

Further, the plurality of light-receiving sections 330 and the N-type transistors 411 and 413 are disposed on the light-receiving chip 201, and the remaining elements are disposed on the detection chip 202.

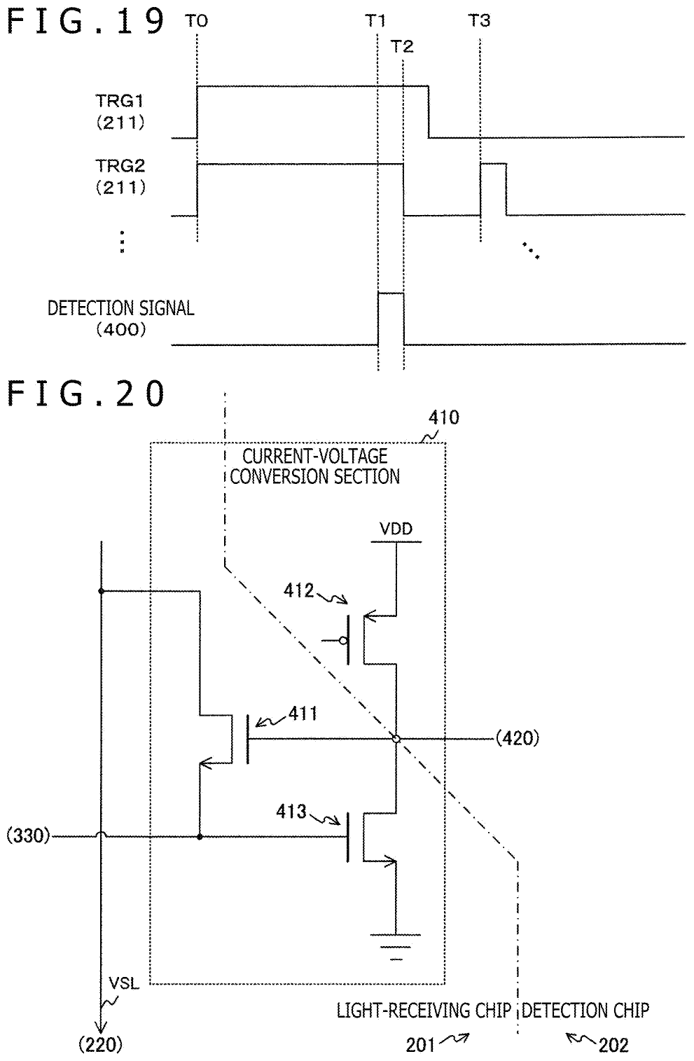

FIG. 19 is a timing chart illustrating exemplary operation of the solid-state imaging element 200 according to the second embodiment of the present technology.

When being instructed to start address event detection at a timing T0, the drive circuit 211 sets all the transfer signals TRGn to the high level to turn on the transfer transistors 331 of all the pixels.

Then, it is assumed that, at a timing T1, the address event detection section 400 detects an address event and outputs a detection signal at the high level.

When receiving the detection signal, at a timing T2, the drive circuit 211 sets only the transfer signal TRG1 to the high level over a certain pulse period. The pixel signal generation section 320 converts the pixel signal of the first pixel to a digital signal.

At a timing T3 after the pixel signal conversion, the drive circuit 211 sets the transfer signal TRG2 at the high level to the high level over a certain pulse period. The pixel signal generation section 320 converts the pixel signal of the second pixel to a digital signal. Similar processing is executed thereafter, so that the pixel signals of the respective pixels in the pixel block 310 are sequentially output.

When all the pixel signals are output, the drive circuit 211 sets all the transfer signals TRGn to the high level to turn on the transfer transistors 331 of all the pixels.

In this way, in the second embodiment of the present technology, since the address event detection section 400 generates the pixel signal SIG, there is no need to dispose the pixel signal generation section 320. With this, the circuit scale can be reduced as compared to the first embodiment in which the pixel signal generation section 320 is disposed.

### Modified Example

In the second embodiment described above, all the elements of the ADC 230 are disposed on the detection chip 202, but this configuration has a risk that, as the number of pixels is increased, the circuit scale of the detection chip 202 is increased. The solid-state imaging element 200 according to a modified example of the second embodiment is different from the second embodiment in that some elements of the ADC 230 are disposed on the light-receiving chip 201, so that the detection chip 202 has a reduced circuit scale.

FIG. 20 is a circuit diagram illustrating a configuration example of the current-voltage conversion section 410 according to the modified example of the second embodiment of the present technology. The current-voltage conversion section 410 according to the modified example of the second embodiment is different from the second embodiment in that the source of the N-type transistor 413 is grounded and the drain of the N-type transistor 411 is connected to the vertical signal line VSL. Note that, as in the second embodiment, instead of the N-type transistor 411, the source of the N-type transistor 413 can also be connected to the vertical signal line VSL.

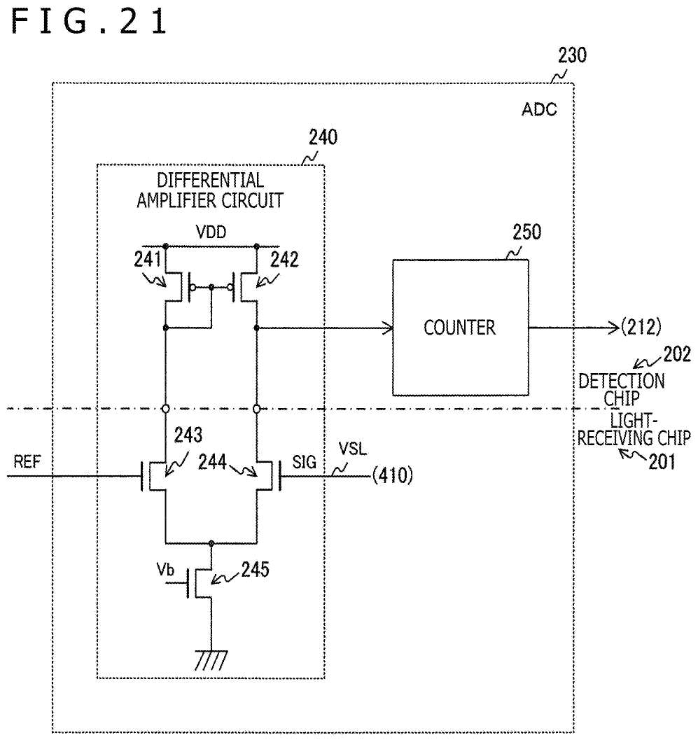

FIG. 21 is a circuit diagram illustrating a configuration example of the ADC 230 according to the modified example of the second embodiment of the present technology. The ADC 230 includes a differential amplifier circuit 240 and a counter 250.

The differential amplifier circuit 240 includes N-type transistors 243, 244, and 245 and P-type transistors 241 and 242. As these transistors, for example, MOS transistors are used.

The N-type transistors 243 and 244 form a differential pair and have sources connected to a drain of the N-type transistor 245 in common. Further, the N-type transistor 243 has a drain connected to a drain of the P-type transistor 241 and gates of the P-type transistors 241 and 242. The N-type transistor 244 has a drain connected to a drain of the P-type transistor 242 and the counter 250. Further, the N-type transistor 243 has a gate to which a reference signal REF is input, and the N-type transistor 244 has a gate to which the pixel signal SIG is input through the vertical signal line VSL. Note that the N-type transistor 243 is an example of a reference-side transistor and the N-type transistor 244 is an example of a signal-side transistor.

As the reference signal REF, for example, a lamp signal is used. A circuit configured to generate the reference signal REF is omitted.

The N-type transistor 245 has a gate to which a predetermined bias voltage Vb is applied and a source grounded. The N-type transistor 245 supplies a constant current. Note that the N-type transistor 245 is an example of a constant current source.

With the configuration described above, the P-type transistors 241 and 242 form a current mirror circuit to amplify a difference between the reference signal REF and the pixel signal SIG and output the resultant to the counter 250. Then, the counter 250 counts a count value over a period required for the signal from the differential amplifier circuit 240 to be inverted and outputs a digital signal indicating the count value to the signal processing section 212.

Further, in the modified example of the second embodiment described above, on the light-receiving chip 201, the N-type transistors 243, 244, and 245 described above are also provided.

In this way, according to the modified example of the second embodiment of the present technology, since the N-type transistors 243, 244, and 245 are also disposed on the light-receiving chip 201, the circuit scale of the detection chip 202 can be reduced as compared to the second embodiment.

### 3. Third Embodiment

In the second embodiment described above, the capacitors 431 and 433 are disposed in the address event detection section 400; however, the gain is deteriorated when the capacitance C1 is reduced with Expression 5, so that it is difficult to enhance an operation speed of the circuit by reducing the capacitance C1. The solid-state imaging element 200 of a third embodiment is different from the second embodiment in that the capacitor 431 is disposed in each pixel to enhance the operation speed.

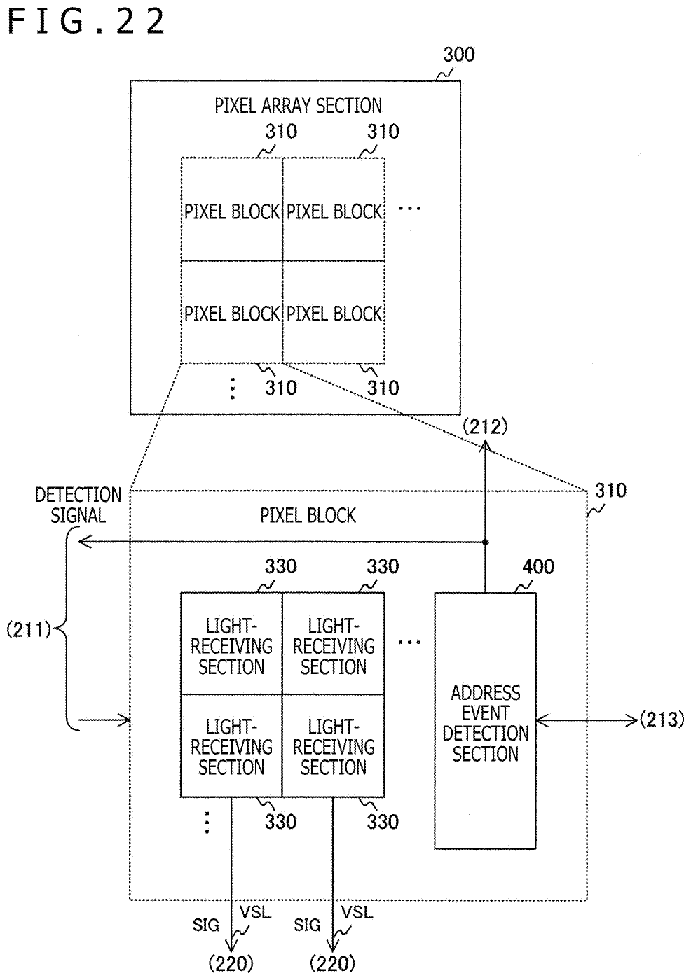

FIG. 22 is a block diagram illustrating a configuration example of the pixel array section 300 according to the third embodiment of the present technology. The pixel array section 300 of the third embodiment is different from the second embodiment in that the light-receiving sections 330 each generate the pixel signal SIG instead of the address event detection section 400. Further, the vertical signal line VSL is routed in each column of the pixels, for example. Further, the ADC 230 is also provided in each column of the pixels. Note that, as in the second embodiment, the vertical signal line VSL can also be disposed in each column of the pixel blocks 310 and the light-receiving sections 330 can also be connected to the vertical signal line VSL. In this case, the ADC 230 is also provided in each column of the pixel blocks 310.

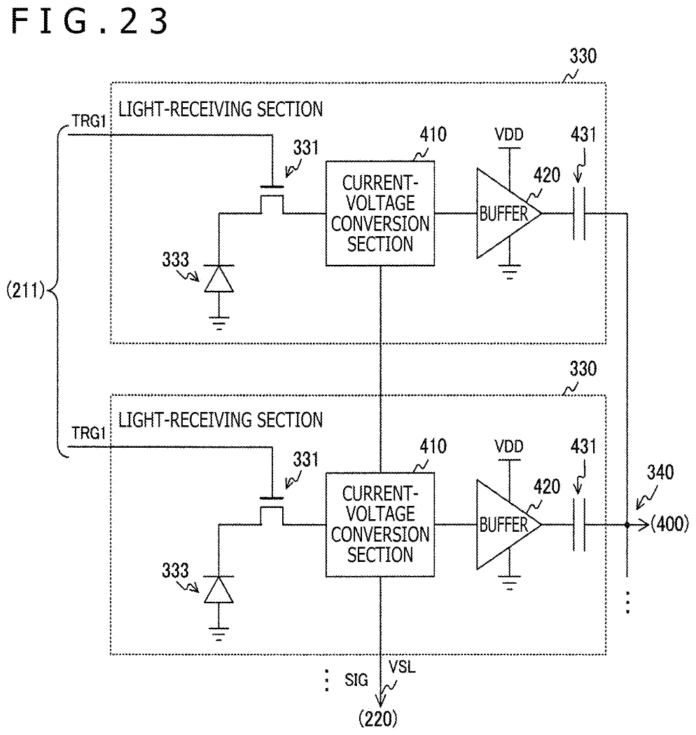

FIG. 23 is a circuit diagram illustrating a configuration example of the light-receiving section 330 according to the third embodiment of the present technology. The light-receiving section 330 of the third embodiment is different from the second embodiment in further including the current-voltage conversion section 410, the buffer 420, and the capacitor 431.

The circuit configuration of the current-voltage conversion section 410 of the third embodiment is similar to that of the modified example of the second embodiment exemplified in FIG. 19, for example. Further, the operation of the drive circuit 211 of the third embodiment is similar to that of the second embodiment. Further, circuits or elements disposed on the light-receiving chip 201 and the detection chip 202 in the third embodiment are similar to those of the modified example of the second embodiment. That is, as exemplified in FIG. 20, in the current-voltage conversion section 410, the N-type transistors 411 and 413 are disposed on the light-receiving chip 201. Further, as exemplified in FIG. 21, in the ADC 230, the N-type transistors 243, 244, and 245 are disposed on the light-receiving chip 201.

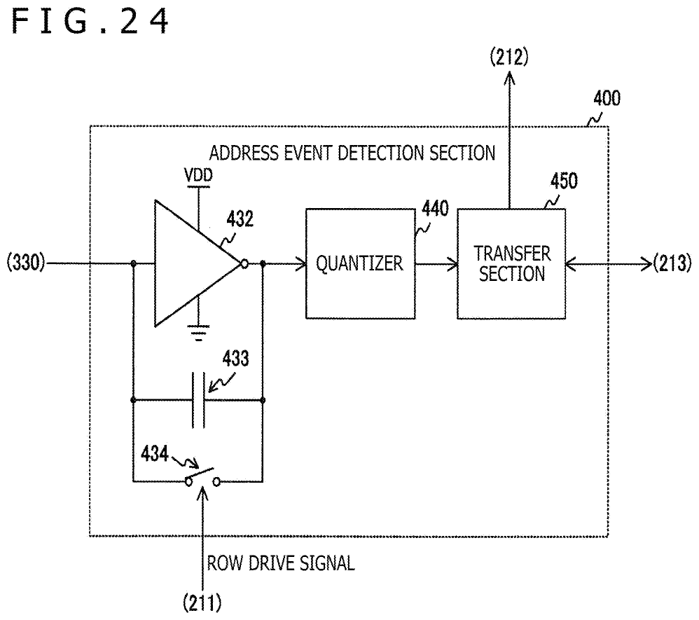

FIG. 24 is a block diagram illustrating a configuration example of the address event detection section 400 according to the third embodiment of the present technology. The address event detection section 400 of the third embodiment is different from the second embodiment in not including the current-voltage conversion section 410, the buffer 420, and the capacitor 431.

As described above, in the third embodiment, the capacitor 431 is provided for each of the light-receiving sections 330 unlike the second embodiment in which the plurality of light-receiving sections 330 connected in parallel shares the single capacitor 431. Thus, the capacitance of the capacitor 431 may be (C1)/N when the number of the light-receiving sections 330 (that is, the number of pixels) is N. The reduction in capacitance can lead to the enhancement of the operation speed of the circuit. However, an entire gain A of the third embodiment is expressed by the following expression.

$$\begin{matrix}[ Math . 2 ] & \\ A = \frac{{CG}_{log} \cdot C 1}{N \cdot C 2} {\sum }_{n = 1}^{N} {i}_{photo} \_n & Expression 7\end{matrix}$$

From Expression 6 and Expression 7, the gain A of the third embodiment is smaller than those of the first and second embodiments. Thus, while the operation speed is enhanced, the address event detection accuracy undesirably drops.

In this way, according to the third embodiment of the present technology, since the capacitor 431 is disposed in each of the light-receiving sections 330, the operation speed of the circuit including the capacitor 431 can be enhanced as compared to the case where the plurality of light-receiving sections 330 shares the capacitor 431.

### Modified Example

In the third embodiment described above, in which the plurality of light-receiving sections 330 (pixels) in a column shares the single ADC 230, there is a need to sequentially convert the pixel signals of the pixels to digital signals, and hence, as the number of pixels in the column is increased, a pixel signal readout speed drops. The solid-state imaging element 200 according to a modified example of the third embodiment is different from the third embodiment in that the ADC 230 is disposed in each pixel.

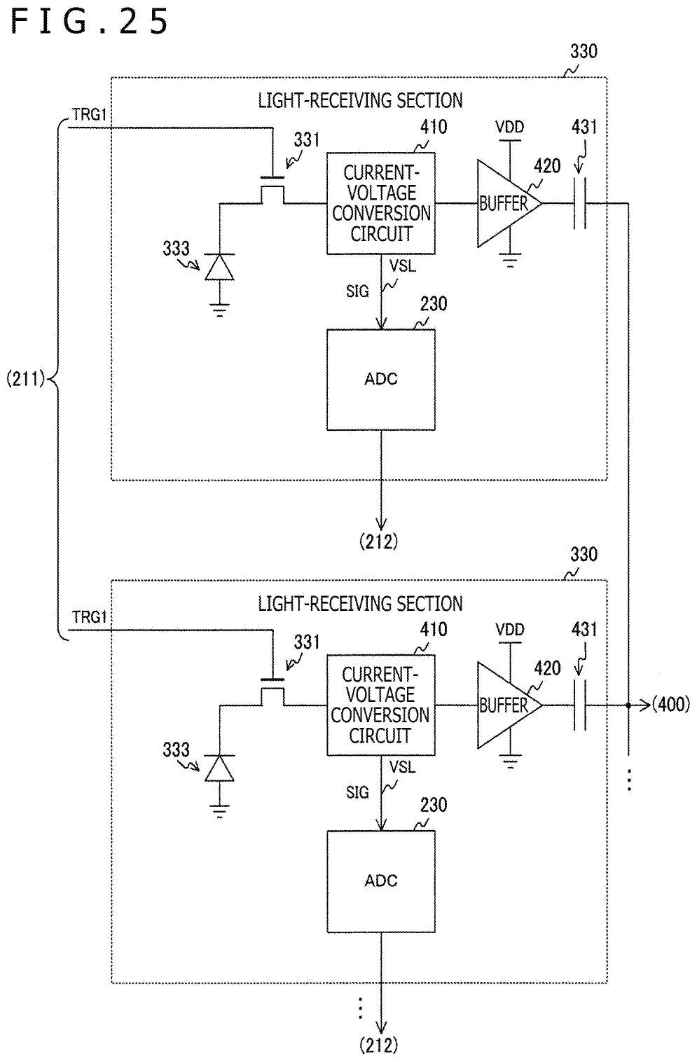

FIG. 25 is a circuit diagram illustrating a configuration example of the light-receiving section 330 according to the modified example of the third embodiment of the present technology. The light-receiving section 330 according to the modified example of the third embodiment is different from the third embodiment in further including the ADC 230.

In this way, according to the modified example of the third embodiment of the present technology, since the ADC 230 is disposed in each of the light-receiving sections 330, the pixel signal readout speed can be enhanced as compared to the configuration in which the plurality of light-receiving sections 330 shares the single ADC 230.

### 4. Fourth Embodiment

In the first embodiment described above, address event detection is performed for each of the pixel blocks 310 each including the plurality of pixels, and address events that have occurred in the individual pixels cannot be detected. The solid-state imaging element 200 of a fourth embodiment is different from the first embodiment in that the address event detection section 400 is disposed in each pixel.

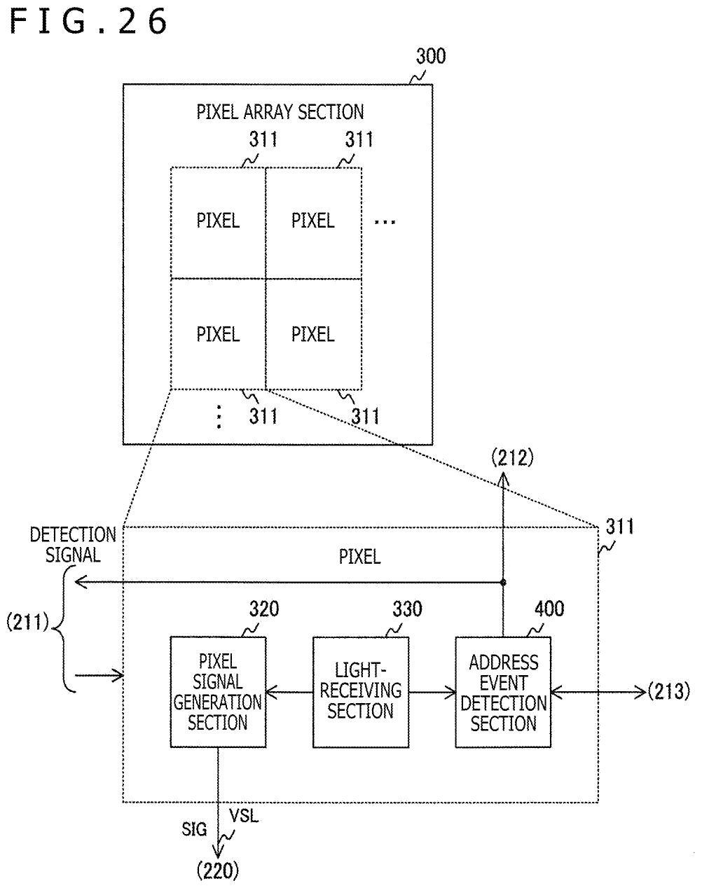

FIG. 26 is a block diagram illustrating a configuration example of the pixel array section 300 according to the fourth embodiment of the present technology. The pixel array section 300 of the fourth embodiment is different from the first embodiment in that a plurality of pixels 311 is arrayed in a two-dimensional lattice pattern. In each of the pixels 311, the pixel signal generation section 320, the light-receiving section 330, and the address event detection section 400 are disposed. The circuit configurations of the pixel signal generation section 320, the light-receiving section 330, and the address event detection section 400 are similar to those of the first embodiment.

Further, circuits or elements disposed on the light-receiving chip 201 or the detection chip 202 are similar to those of the first embodiment or any of the first, second, and third modified examples of the first embodiment. For example, as exemplified in FIG. 5, only the photoelectric conversion element 333 is disposed on the light-receiving chip 201, and the remaining elements are disposed on the detection chip 202.

In this way, according to the fourth embodiment of the present technology, since the address event detection section 400 is disposed in each pixel, address event detection is performed for each pixel. With this, the resolution of address event detection data can be enhanced as compared to the case where address event detection is performed for each of the pixel blocks 310.

### Modified Example

In the fourth embodiment described above, the address event detection section 400 is disposed in every pixel, but this configuration has a risk that, as the number of pixels is increased, the circuit scale of the solid-state imaging element 200 is increased. The solid-state imaging element 200 according to a modified example of the fourth embodiment is different from the fourth embodiment in that the address event detection section 400 is disposed only in the detection target pixel of the plurality of pixels.

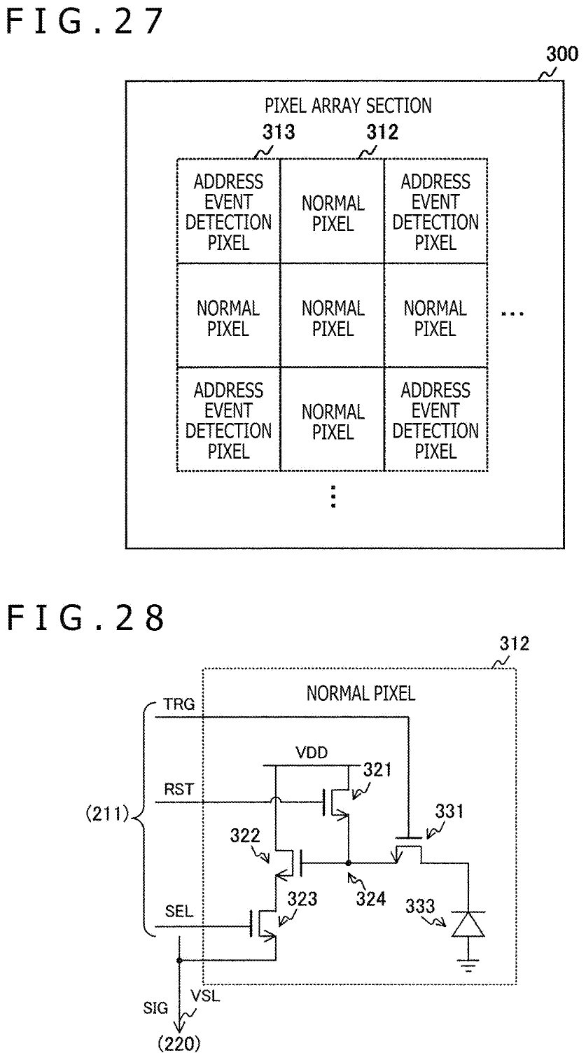

FIG. 27 is a block diagram illustrating a configuration example of the pixel array section 300 according to the modified example of the fourth embodiment of the present technology. The pixel array section 300 according to the modified example of the fourth embodiment is different from the fourth embodiment in that a pixel not including the address event detection section 400 and a pixel including the address event detection section 400 are arrayed. The former is referred to as a “normal pixel 312,” and the latter is referred to as an “address event detection pixel 313.” The address event detection pixels 313 are separately disposed at certain intervals, for example. Note that the plurality of address event detection pixels 313 can also be adjacent to each other.

Further, a configuration of the address event detection pixel 313 is similar to that of the pixel 311 of the fourth embodiment. Details of the normal pixel 312 are described below.

FIG. 28 is a circuit diagram illustrating a configuration example of the normal pixel 312 according to the modified example of the fourth embodiment of the present technology. The normal pixel 312 according to the modified example of the fourth embodiment includes the photoelectric conversion element 333, the transfer transistor 331, the reset transistor 321, the amplifier transistor 322, the select transistor 323, and the floating diffusion layer 324. A connection configuration of these elements is similar to that of the first embodiment exemplified in FIG. 5.

In this way, according to the modified example of the fourth embodiment of the present technology, since the address event detection section 400 is disposed only in the address event detection pixel 313 of all the pixels, the circuit scale can be reduced as compared to the configuration in which the address event detection section 400 is disposed in every pixel.

### 5. Fifth Embodiment

In the first embodiment described above, the number of pixels that share the address event detection section 400 and the number of pixels that share the pixel signal generation section 320 are the same, but the latter can also be smaller than the former. The solid-state imaging element 200 according to a fifth embodiment is different from the first embodiment in that the number of pixels that share the pixel signal generation section 320 is smaller than the number of pixels that share the address event detection section 400.

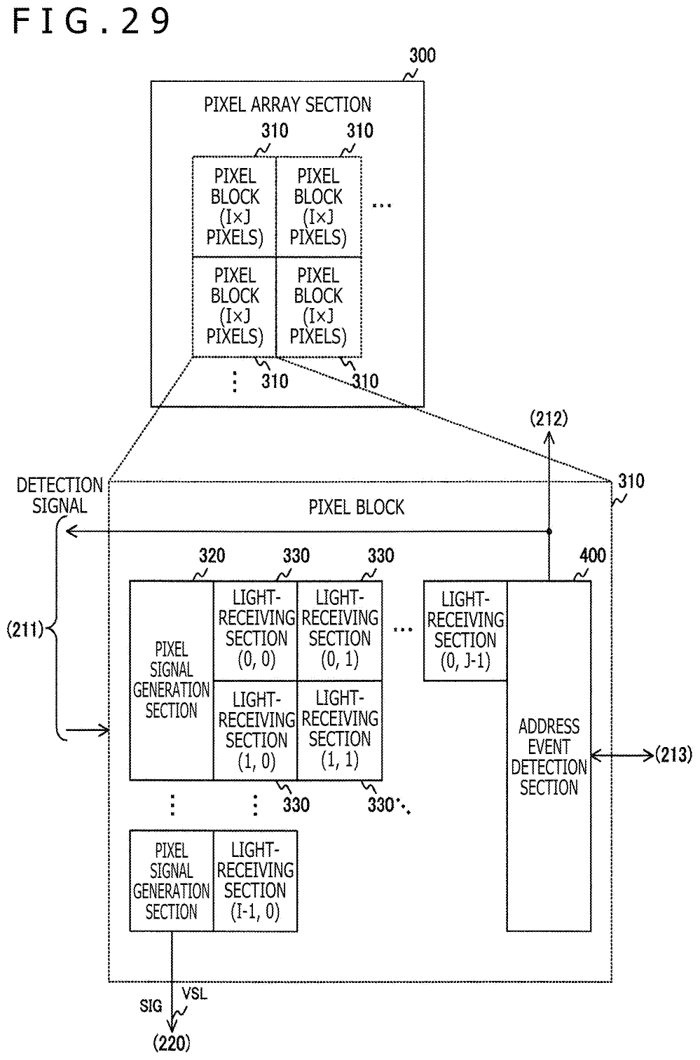

FIG. 29 is a block diagram illustrating a configuration example of the pixel array section 300 according to the fifth embodiment of the present technology. In the pixel array section 300 of the fifth embodiment, in each of the pixel blocks 310, the N light-receiving sections 330 (pixels) and the single address event detection section 400 are disposed. Further, in each of the pixel blocks 310, the pixel signal generation section 320 is disposed for every M (M is a natural number smaller than N) light-receiving sections 330 (pixels).

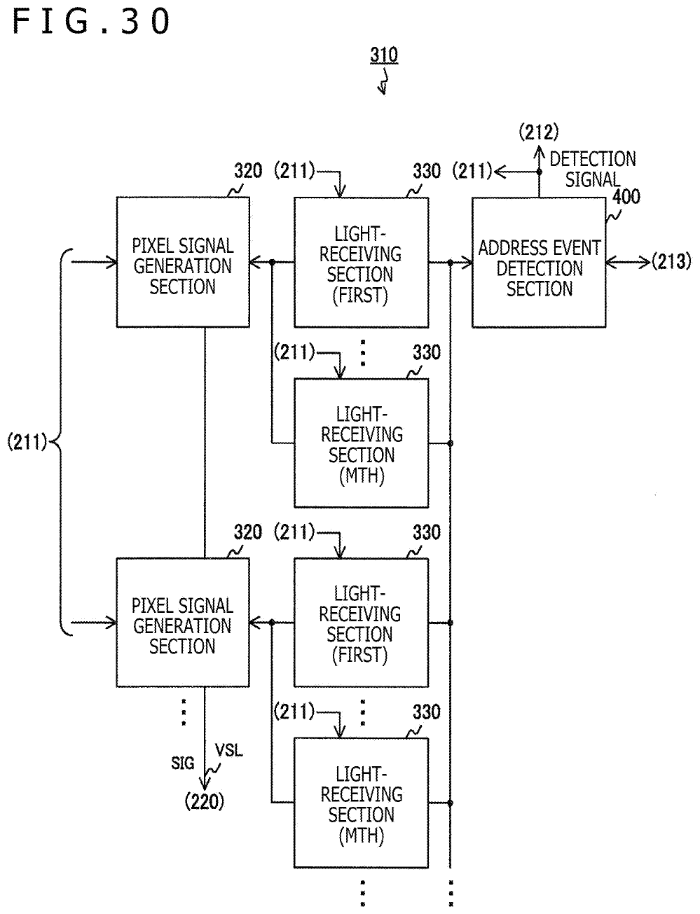

FIG. 30 is a block diagram illustrating a configuration example of the pixel block 310 according to the fifth embodiment of the present technology. In each of the pixel blocks 310, the N light-receiving sections 330 (pixels) share the single address event detection section 400. Further, the M pixels share the single pixel signal generation section 320. The pixel signal generation section 320 generates a pixel signal for a pixel selected from the corresponding M pixels.

In this way, according to the fifth embodiment of the present technology, since the number of pixels that share the pixel signal generation section 320 is smaller than the number of pixels that share the address event detection section 400, the pixel signal readout speed can be enhanced as compared to the case where the pixel signal generation section 320 and the address event detection section 400 are shared by the same number of pixels.

### 6. Sixth Embodiment

[Configuration Example of Event Detection Device]

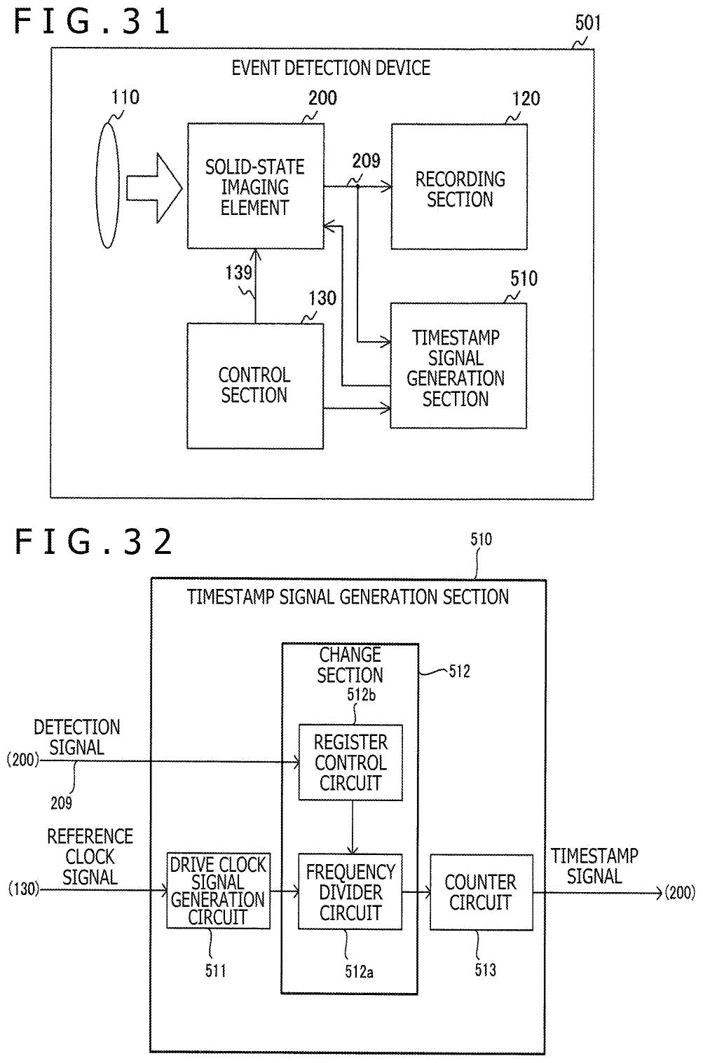

FIG. 31 is a block diagram illustrating a configuration example of an event detection device 501 according to a sixth embodiment of the present technology. The event detection device 501 includes the imaging lens 110 and the solid-state imaging element 200 including the plurality of photoelectric conversion elements 333 (see FIG. 5) each configured to perform photoelectric conversion on incident light to generate an electrical signal and the address event detection section (example of detection section) 400 (see FIG. 3) configured to output a detection signal indicating the result of detection of whether or not the amount of change in electrical signal of each of the plurality of photoelectric conversion elements 333 exceeds a predetermined threshold. Further, the event detection device 501 includes the recording section 120 connected to the solid-state imaging element 200 and the control section 130 configured to control the solid-state imaging element 200. Moreover, the event detection device 501 includes a timestamp signal generation section 510 configured to generate a timestamp signal that is used for indicating a time point at which the address event detection section 400 has detected a detection signal. As the event detection device 501, a camera that is installed on an industrial robot, a vehicle-mounted camera, or the like is assumed.

The imaging lens 110 of the present embodiment is the same as the imaging lens 110 of one of the first to fifth embodiments described above in terms of configuration and function.

The solid-state imaging element 200 of the present embodiment is different from the solid-state imaging element 200 of one of the first to fifth embodiments described above in being connected to the timestamp signal generation section 510. The signal processing section 212 (see FIG. 3) provided in the solid-state imaging element 200 records, using a timestamp signal (described in detail later) input from the timestamp signal generation section 510, a time point at which the address event detection section 400 (see FIG. 4) has detected an address event. More specifically, the signal processing section 212 stores a time point at which an address event detection signal has been input from the address event detection section 400 as a time point at which the address event has been detected. Thus, between a time point stored by the signal processing section 212 as a time point at which an address event detection signal has been detected and a time point at which the address event detection signal has actually been detected, there is a time difference based on time required for the address event detection section 400 to request detection signal transmission to the arbiter 213 and receive the response. However, the time difference affects all the pixel blocks 310 (see FIG. 4) provided in the pixel array section 300 of the solid-state imaging element 200, and thus, does not cause any trouble in image processing or the like.

The signal processing section 212 transmits, as a set, a detection signal for an address event, the coordinates of the light-receiving section 330 (see FIG. 4) that has detected the address event, and the detection time point of the detection signal (time point information included in the timestamp signal) to the recording section 120 and the timestamp signal generation section 510.

The recording section 120 stores the coordinates of the light-receiving section 330 (see FIG. 4) that has detected an address event, which is input together with the address event detection signal from the signal processing section 212 of the solid-state imaging element 200, and the detection time point of the detection signal (the time point information included in the timestamp signal) in association with each other. In this way, the recording section 120 is different from the recording section 120 of one of the first to fifth embodiments described above in recording the time point information included in the timestamp signal.

The control section 130 is different from the recording section 120 of one of the first to fifth embodiments described above in transmitting a reference clock signal to the timestamp signal generation section 510. The reference clock signal is a clock signal with which the control section 130, the solid-state imaging element 200, the recording section 120, and the timestamp signal generation section 510 of the event detection device 501 operate in synchronization with each other.

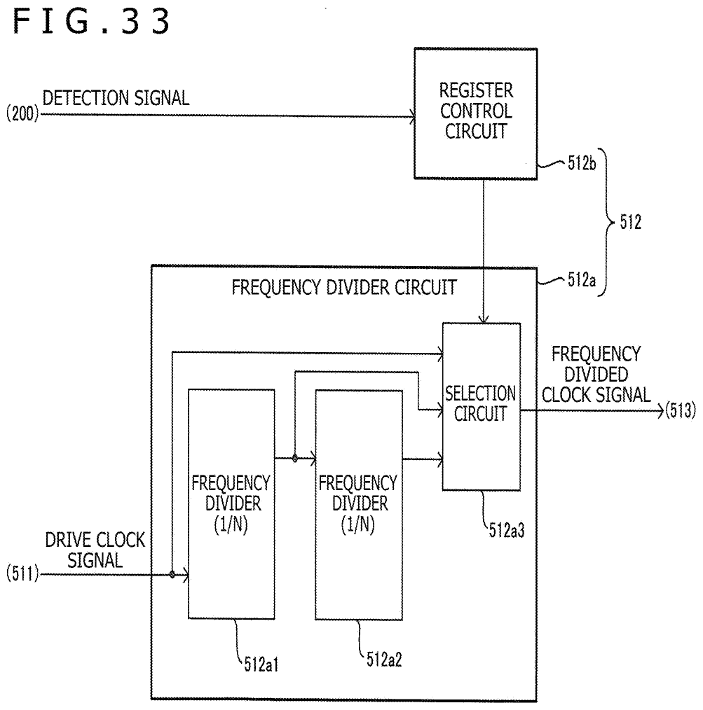

As illustrated in FIG. 31, the timestamp signal generation section 510 is connected to the signal line 209 to be connected to the solid-state imaging element 200 through the signal line 209. With this, the timestamp signal generation section 510 can receive a detection signal from the signal processing section 212. Here, the timestamp signal generation section 510 is described using FIG. 32 to FIG. 36 with reference to FIG. 31. First, a schematic configuration of the timestamp signal generation section 510 is described using FIG. 32 and FIG. 33. FIG. 32 is a block diagram illustrating a configuration example of the timestamp signal generation section 510. FIG. 33 is a block diagram illustrating a configuration example of a change section 512 provided in the timestamp signal generation section 510.

As illustrated in FIG. 32, the timestamp signal generation section 510 includes a drive clock signal generation circuit 511 connected to the control section 130 (see FIG. 31). With this, the drive clock signal generation circuit 511 receives a reference clock signal output from the control section 130. The drive clock signal generation circuit 511 shapes a waveform of a reference clock signal input from the control section 130, thereby generating a drive clock signal. The drive clock signal generation circuit 511 includes, for example, a D flip-flop circuit (not illustrated) having a clock signal input terminal for receiving a reference clock signal and an inverting output terminal connected to the input terminal. The drive clock signal generation circuit 511 can frequency-divide a frequency of a reference clock signal to generate a waveform-shaped drive clock signal having a frequency that is ½ of that of the reference clock signal.

As illustrated in FIG. 32, the event detection device 501 includes the change section 512 provided in the timestamp signal generation section 510 and configured to change a timestamp signal temporal resolution in a case where a detection frequency of address event detection signals exceeds a predetermined threshold (an upper or lower limit value of a currently set timestamp signal temporal resolution in the present embodiment) (an example of a case where a predetermined condition is satisfied). The change section 512 determines that a predetermined condition for changing the timestamp signal temporal resolution is satisfied in a case where the detection frequency of address event detection signals exceeds a predetermined threshold.

As illustrated in FIG. 32, the change section 512 includes a register control circuit (example of storage section) 51b configured to store a plurality of timestamp signal temporal resolutions in association with the detection frequency of address event detection signals (example of predetermined condition). The register control circuit 512b can set the currently set timestamp signal temporal resolution. The register control circuit 512b is connected to the signal line 209. The register control circuit 512b is connected to the solid-state imaging element 200 (see FIG. 31) through the signal line 209. With this, the register control circuit 512b receives information including, as a set, a detection signal for an address event, the coordinates of the light-receiving section 330 (see FIG. 4) that has detected the address event, and the detection time point of the detection signal (the time point information included in the timestamp signal).

The register control circuit 512b extracts information regarding the detection time points of the address event signals from the information to calculate the detection frequency of address event detection signals. Further, the register control circuit 512b calculates the detection frequency of address event detection signals for each of the pixel blocks 310 and uses, for example, an average value of the detection frequencies for the pixel blocks 310 as the detection frequency of address event detection signals in the solid-state imaging element 200. The timestamp signal generation section 510 calculates, when calculating the detection frequency of address event detection signals, a detection frequency for each of the light-receiving sections 330 at the same coordinates. Moreover, the register control circuit 512b outputs, in a case where a reciprocal of the calculated average value exceeds or falls below the upper or lower limit value of the currently set timestamp signal temporal resolution (example of predetermined threshold), an instruction signal including instruction information regarding changing the timestamp signal temporal resolution to low or high resolution to a frequency divider circuit 512a (described in detail later). In the present embodiment, there is a case where the reciprocal of the detection frequency of address event detection signals that has been smaller than the upper limit value of the currently set timestamp signal temporal resolution exceeds the upper limit value, so that the timestamp signal temporal resolution exceeds the upper limit value (example of predetermined threshold). Further, in the present embodiment, there is a case where the reciprocal of the detection frequency of address event detection signals that has been larger than the lower limit value of the currently set timestamp signal temporal resolution falls below the lower limit value, so that the timestamp signal temporal resolution falls below the lower limit value (example of predetermined threshold).

As illustrated in FIG. 32, the change section 512 includes the frequency divider circuit 512a configured to divide the frequency of a drive clock signal (example of clock signal based on reference clock signal). The frequency divider circuit 512a changes the number of times of frequency division on the basis of temporal resolution information input from the register control circuit 512b. A specific configuration of the frequency divider circuit 512a is described later.

The timestamp signal generation section 510 includes a counter circuit 513 configured to output, as a timestamp signal, a count value obtained by counting the number of clocks (that is, clock frequency) of a frequency divided clock signal (described in detail later) that is a clock signal having a frequency obtained by division by the frequency divider circuit 512a (see FIG. 33; the details are described later) provided in the change section 512. The counter circuit 513 is connected to the signal processing section 212 provided in the solid-state imaging element 200. With this, the counter circuit 513 can output a timestamp signal to the signal processing section 212. The counter circuit 513 receives, at the clock signal input terminal, a frequency divided clock signal output from the change section 512. With this, the counter circuit 513 can count the number of clocks of the frequency divided clock signal.

As illustrated in FIG. 33, the frequency divider circuit 512a includes a first-stage frequency divider 512a1 configured to receive a drive clock signal output from the drive clock signal generation circuit 511 (see FIG. 32). Further, the frequency divider circuit 512a includes a second-stage frequency divider 512a2 configured to receive a clock signal output from the first-stage frequency divider 512a1 (hereinafter sometimes referred to as a “first-stage clock signal”). Moreover, the frequency divider circuit 512a includes a selection circuit 512a3 configured to receive a drive clock signal output from the drive clock signal generation circuit 511, a first-stage clock signal output from the first-stage frequency divider 512a1, a clock signal output from the second-stage frequency divider 512a2 (hereinafter sometimes referred to as a “second-stage clock signal”), and an instruction signal output from the register control circuit 512b (see FIG. 32).

The first-stage frequency divider 512a1 divides the frequency of a drive clock signal by 1/N (for example, N=100) to obtain a first-stage clock signal and outputs the first-stage clock signal to the second-stage frequency divider 512a2 and the selection circuit 512a3. The second-stage frequency divider 512a2 divides the frequency of a first-stage clock signal output from the first-stage frequency divider 512a1 by 1/N (for example, N=100) to obtain a second-stage clock signal and outputs the second-stage clock signal to the selection circuit 512a3. Thus, the clock signal generated by the second-stage frequency divider 512a2 has a frequency obtained by dividing the frequency of a drive clock signal by 1/N². For example, in a case where the frequency of a drive clock signal is 10 GHz, the first-stage frequency divider 512a1 generates a first-stage clock signal at 100 MHz (=10 GHz/100), for example, and the second-stage frequency divider 512a2 generates a second-stage clock signal at 1 MHz (=100 MHz/100 (10 GHz/100²)), for example.

The selection circuit 512a3 selects, on the basis of an instruction signal output from the register control circuit 512b, any one of a drive clock signal, a first-stage clock signal, and a second-stage clock signal and outputs the selected clock signal as a frequency division counter signal. The selection circuit 512a3 selects, in a case where it is determined that an instruction signal output from the register control circuit 512b includes instruction information regarding reducing the timestamp signal temporal resolution, a clock signal having a frequency one step lower than that of the currently selected clock signal. Further, the selection circuit 512a3 selects, in a case where it is determined that an instruction signal output from the register control circuit 512b includes instruction information regarding increasing the timestamp signal temporal resolution, a clock signal having a frequency one step higher than that of the currently selected clock signal. Moreover, the selection circuit 512a3 continues selecting the currently selected clock signal in a case where no instruction signal is input from the register control circuit 512b.

When the selection circuit 512a3 receives, for example, while selecting a drive clock signal, an instruction signal including instruction information regarding reducing the timestamp signal temporal resolution, the selection circuit 512a3 selects a first-stage clock signal having a frequency one step lower than that of the drive clock signal. The selection circuit 512a3 outputs the selected first-stage clock signal to the counter circuit 513 as a timestamp signal. Further, when the selection circuit 512a3 receives, for example, while selecting a first-stage clock signal, an instruction signal including instruction information regarding reducing the timestamp signal temporal resolution, the selection circuit 512a3 selects a second-stage clock signal having a frequency one step lower than that of the first-stage clock signal. The selection circuit 512a3 outputs the selected second-stage clock signal to the counter circuit 513 as a timestamp signal.

When the selection circuit 512a3 receives, for example, while selecting a second-stage clock signal, an instruction signal including instruction information regarding increasing the timestamp signal temporal resolution, the selection circuit 512a3 selects a first-stage clock signal having a frequency one step higher than that of the second-stage clock signal. The selection circuit 512a3 outputs the selected first-stage clock signal to the counter circuit 513 as a timestamp signal. Further, when the selection circuit 512a3 receives, for example, while selecting a first-stage clock signal, an instruction signal including instruction information regarding increasing the timestamp signal temporal resolution, the selection circuit 512a3 selects a drive clock signal having a frequency one step higher than that of the first-stage clock signal. The selection circuit 512a3 outputs the selected drive clock signal to the counter circuit 513 as a timestamp signal.

When the selection circuit 512a3 receives, for example, while selecting a drive clock signal, an instruction signal including instruction information regarding increasing the timestamp signal temporal resolution, the selection circuit 512a3 continues selecting the drive clock signal. When the selection circuit 512a3 receives, for example, while selecting a second-stage clock signal, an instruction signal including instruction information regarding reducing the timestamp signal temporal resolution, the selection circuit 512a3 continues selecting the second-stage clock signal.

In this way, the selection circuit 512a3 outputs, to the counter circuit 513, clock signals having different frequencies, depending on the detection frequency of address event detection signals. The counter circuit 513 continues counting without resetting the count value even when the frequency of the input clock signal is changed.

Note that the configuration of the frequency divider circuit 512a is not limited to the configuration illustrated in FIG. 33. For example, the number of stages of frequency dividers provided in the frequency divider circuit 512a is not limited to two and may be one or three or more. Further, the frequency divider circuit 512a may include a phase locked loop (PLL) such that the frequency divider circuit 512a can change the frequency of a drive clock signal by dividing or multiplying the frequency.

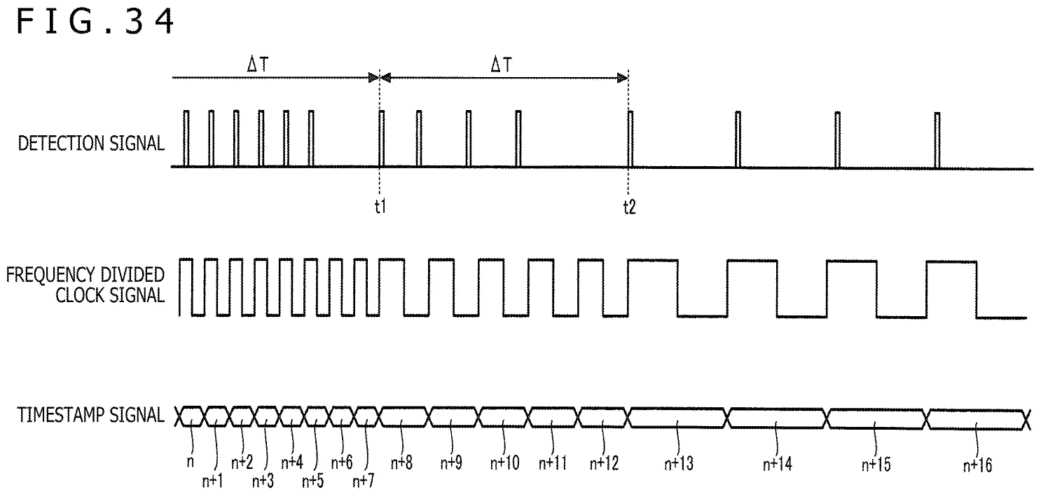

Next, exemplary operation of the timestamp signal generation section 510 is described using FIG. 34 with reference to FIG. 31 to FIG. 33. FIG. 34 is a timing chart illustrating exemplary operation of the timestamp signal generation section 510 included in the event detection device 501 of the present embodiment. “Detection signal” illustrated on the first line in FIG. 34 represents an address event detection signal that is input from the solid-state imaging element 200 to the timestamp signal generation section 510. In FIG. 34, rectangle frames illustrated on the first line in FIG. 34 represent a detection signal detected state. “Frequency divided clock signal” illustrated on the second line in FIG. 34 represents a frequency divided clock signal that is input from the change section 512 to the counter circuit 513. “Timestamp signal” illustrated on the third line in FIG. 34 represents a timestamp signal that is output from the timestamp signal generation section 510 to the solid-state imaging element 200. In FIG. 34, the time elapses from the left to the right. Further, to facilitate the understanding, FIG. 34 illustrates a case where the frequency divided clock signal is subjected to ½ frequency division such that the frequency divided clock signal has the same frequency as the drive clock signal until a time t1, the same frequency as the first-stage clock signal in a period of from the time t1 to a time t2, and the same frequency as the second-stage clock signal at and after the time t2.

It is assumed that, in the period until the time t1 illustrated in FIG. 34, an instruction signal that is input from the register control circuit 512b (see FIG. 32) to the selection circuit 512a3 (see FIG. 33) provided in the frequency divider circuit 512a includes a minimum value of the timestamp signal temporal resolution (for example, the same value as the reciprocal of the drive clock signal frequency). With this, the selection circuit 512a3 selects the drive clock signal, thereby outputting, as illustrated in FIG. 34, a frequency divided clock signal having the same frequency (same period) as the drive clock signal to the counter circuit 513 (see FIG. 32). For example, every time the input frequency divided clock signal rises, the counter circuit 513 counts the number of clocks of the frequency divided clock signal and outputs a timestamp signal including the count value to the solid-state imaging element 200 (see FIG. 31). In FIG. 34, count values n to n+7 (n is a natural number) included in the timestamp signal are illustrated. In the period until the time t1, the frequency of the frequency divided clock signal is, for example, 10 GHz, and the temporal resolution of the timestamp signal is, for example, 100 psec.

When, at the time t1, a period in which the detection frequency of address event detection signals is calculated (hereinafter sometimes referred to as a “calculation target period”) ΔT starts, the register control circuit 512b calculates the detection frequency of address event detection signals in the calculation target period ΔT. For example, the register control circuit 512b divides the number of address events detected in the calculation target period ΔT until the time t1 by the calculation target period ΔT, to thereby calculate the detection frequency of address event detection signals.

It is assumed that the reciprocal of the detection frequency of address event detection signals calculated by the register control circuit 512b at the time t1 is larger than the currently set timestamp signal temporal resolution (in this example, the same value as the period of the drive clock signal), for example. In this case, the change section 512 determines that the detection frequency of address event detection signals has exceeded a predetermined threshold. Thus, the register control circuit 512b outputs, to the selection circuit 512a3, an instruction signal including information regarding temporal resolution having the same value as the period of the first-stage clock signal and instruction information regarding setting the timestamp signal temporal resolution to low resolution, for example. With this, the selection circuit 512a3 selects the first-stage clock signal, thereby outputting a frequency divided clock signal having the same frequency (same period) as the first-stage clock signal to the counter circuit 513 (see FIG. 32). Thus, as illustrated in FIG. 34, the period of the frequency divided clock signal is long (low frequency) from the time t1. Every time the input frequency divided clock signal rises, for example, the counter circuit 513 counts the number of clocks of the frequency divided clock signal and outputs a timestamp signal including the count value to the solid-state imaging element 200. The counter circuit 513 does not reset the count value even when the period of the frequency divided clock signal is changed. Thus, as illustrated in FIG. 34, around the time t1, the counter circuit 513 outputs, next to the timestamp signal including the count value “n+7,” a timestamp signal including a count value “n+8.” In the period from the time t1 to the time t2, which is described below, the frequency of the frequency divided clock signal is, for example, 100 MHz, and the temporal resolution of the timestamp signal is, for example, 10 nsec.

At the time t2 that comes after a period corresponding to the calculation target period ΔT has elapsed from the time t1, the register control circuit 512b calculates the detection frequency of address event detection signals in the calculation target period ΔT from the time t1 to the time t2. It is assumed that the reciprocal of the detection frequency of address event detection signals calculated by the register control circuit 512b at the time t2 is larger than the currently set timestamp signal temporal resolution (in this example, the same value as the period of the first-stage clock signal), for example. In this case, the change section 512 determines that the detection frequency of address event detection signals has exceeded a predetermined threshold. Thus, the register control circuit 512b outputs, to the selection circuit 512a3, an instruction signal including information regarding temporal resolution having the same value as the period of the second-stage clock signal and instruction information regarding setting the timestamp signal temporal resolution to low resolution. With this, the selection circuit 512a3 selects the second-stage clock signal, thereby outputting a frequency divided clock signal having the same frequency (same period) as the second-stage clock signal to the counter circuit 513. Thus, as illustrated in FIG. 34, the period of the frequency divided clock signal is long (low frequency) from the time t2. Every time the input frequency divided clock signal rises, for example, the counter circuit 513 counts the number of clocks of the frequency divided clock signal and outputs a timestamp signal including the count value to the solid-state imaging element 200. The counter circuit 513 does not reset the count value even when the period of the frequency divided clock signal is changed. Thus, as illustrated in FIG. 34, around the time t2, the counter circuit 513 outputs, next to a timestamp signal including a count value “n+12,” a timestamp signal including a count value “n+13.” At and after a time t3, the frequency of the frequency divided clock signal is, for example, 1 MHz, and the temporal resolution of the timestamp signal is, for example, 1 psec.

FIG. 34 exemplifies the timing chart of the timestamp signal generation section 510 in the case where the timestamp signal temporal resolution is set to low resolution. In a case where the reciprocal of the detection frequency of address event detection signals calculated by the register control circuit 512b is smaller than the currently set timestamp signal temporal resolution, however, the timestamp signal temporal resolution is set to high resolution. As a result, the period of the timestamp signal is short (high frequency).

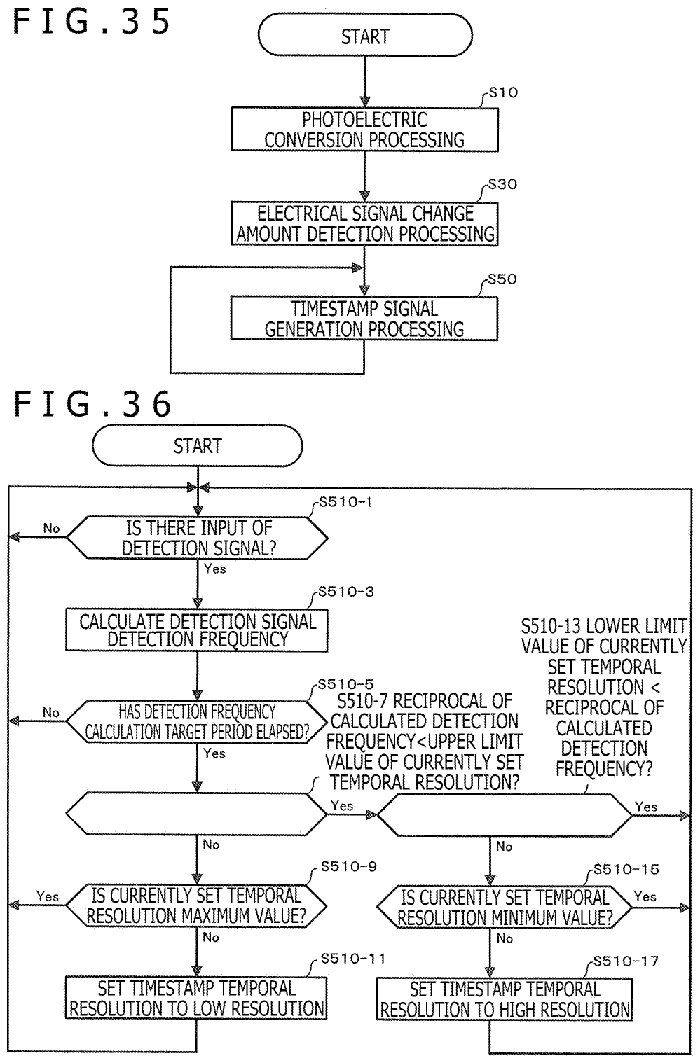

Next, an event detection method of the present embodiment is described using FIG. 35 with reference to FIG. 5 and FIG. 31 to FIG. 34. FIG. 35 is a flowchart illustrating an exemplary flow of the operation of the event detection method in the event detection device 501. The event detection method of the present embodiment mainly corresponds to a timestamp signal generation method. When being powered on, the event detection device 501 starts the operation illustrated in FIG. 35. When being powered off, the event detection device 501 ends the operation.

(Step S10)

As illustrated in FIG. 35, when starting to operate, the event detection device 501 executes photoelectric conversion processing and transitions to the processing in Step S30. In the photoelectric conversion processing in Step S10, the solid-state imaging element 200 performs photoelectric conversion on incident light, which is incident thereon, by the photoelectric conversion element 333 (see FIG. 5), to thereby generate an electrical signal.

(Step S30)

In Step S30, the electrical signal change amount detection processing is executed, and the processing transitions to the processing in Step S50. More specifically, in Step S30, the address event detection section (example of detection section) 400 (see FIG. 5) detects whether or not the amount of change in electrical signal generated by the photoelectric conversion element 333 exceeds a predetermined threshold and outputs a detection signal. Although the detailed description is not given, in Step S30, in a case where the address event detection section 400 detects an on event indicating that the amount of change in photocurrent from each of the light-receiving sections 330 exceeds an upper limit threshold or an off event indicating that the amount of change falls below a lower limit threshold, the address event detection section 400 outputs the detection result as a detection signal.

(Step S50)

In Step S50, the timestamp signal generation processing is executed. More specifically, in Step S50, the timestamp signal generation section 510 (see FIG. 32 and FIG. 33) generates a timestamp signal (see FIG. 34) that is used for indicating a time point at which the address event detection section 400 has detected the detection signal. Although the detailed description is not given, in Step S50, the timestamp signal generation section 510 generates the timestamp signal as described with reference to FIG. 31 to FIG. 34 and outputs the timestamp signal to the solid-state imaging element 200. The processing in Step S50 is executed every time a detection signal is output from the address event detection section 400 in Step S30.

Further, in the timestamp signal generation processing, the timestamp temporal resolution change processing is executed. In the timestamp temporal resolution change processing, the change section 512 provided in the timestamp signal generation section 510 changes the timestamp signal temporal resolution in a case where a predetermined condition is satisfied. Meanwhile, in the timestamp temporal resolution change processing, the change section 512 provided in the timestamp signal generation section 510 does not change the timestamp signal temporal resolution in a case where the predetermined condition is not satisfied. As described above, the case where the predetermined condition is satisfied in the present embodiment corresponds, for example, to the case where the detection frequency of address event detection signals exceeds a predetermined threshold (the upper or lower limit value of the currently set timestamp signal temporal resolution in the present embodiment). The specific processing of the timestamp temporal resolution change processing is described below.

Next, an exemplary flow of the operation of the timestamp signal generation section 510 (timestamp temporal resolution change processing) included in the event detection device 501 of the present embodiment is described using FIG. 36 with reference to FIG. 31 to FIG. 34. FIG. 36 is a flowchart illustrating an exemplary flow of the operation of the timestamp signal generation section 510. The timestamp signal generation section 510 starts the operation illustrated in FIG. 36 when the event detection device 501 is powered on. The timestamp signal generation section 510 ends the operation when the event detection device 501 is powered off.

(Step S510-1)

As illustrated in FIG. 36, when starting to operate, the timestamp signal generation section 510 (see FIG. 32) first determines whether or not there is the input of an address event detection signal. The timestamp signal generation section 510 transitions to the processing in Step S510-3 in a case where it is determined that an address event detection signal has been input from the solid-state imaging element 200 (see FIG. 31). Meanwhile, the timestamp signal generation section 510 repeatedly executes the processing in Step S510-1 in a case where it is determined that no address event detection signal has been input from the solid-state imaging element 200. The timestamp signal generation section 510 repeatedly executes, until an address event detection signal is input, the processing in Step S510-1 at time intervals smaller than the minimum value of timestamp signal temporal resolution.

In this way, the timestamp signal generation section 510 repeatedly executes the processing in Step S510-1 at the time intervals smaller than the minimum value of timestamp signal temporal resolution, to thereby determine every address event detection signal input without fail. The processing in Step S510-1 is executed by the register control circuit 512b, for example.

(Step S510-3)

In Step S510-3, the timestamp signal generation section 510 calculates the detection frequency of address event detection signals and transitions to the processing in Step S510-3. The timestamp signal generation section 510 adds 1 (corresponding to an address event detection signal detected this time) to the number of address event detection signals detected in a calculation target period including the current time point, and divides the addition result by the calculation target period. With this, the timestamp signal generation section 510 can calculate the detection frequency of address event detection signals at the current time point.

The timestamp signal generation section 510 calculates the detection frequency of address event detection signals for each of the light-receiving sections 330 at the same coordinates. Further, the timestamp signal generation section 510 sets, as the detection frequency of address event detection signals in the calculation target period including the current time point, a representative value, such as the average value, the minimum value, or the maximum value, of the detection frequencies of address event detection signals of all the light-receiving sections 330 provided in the pixel array section 300. The value, the number of detected address event detection signals, and the detection frequency of address event detection signals in the calculation target period may be stored in the register control circuit 512b, for example. Further, the timestamp signal generation section 510 may include, for example, a storage section, which is not illustrated, and may store the calculation target period, the number of detected address event detection signals, and the detection frequency of address event detection signals in the storage section. The processing in Step S510-3 is executed by the register control circuit 512b, for example.

(Step S510-5)

In Step S510-5, the timestamp signal generation section 510 determines whether or not the calculation target period of the detection frequency of address event detection signals has elapsed. The timestamp signal generation section 510 transitions to the processing in Step S510-7 in a case where it is determined that the calculation target period has elapsed (Yes). Meanwhile, the timestamp signal generation section 510 returns to the processing in Step S510-1 in a case where it is determined that the calculation target period has not elapsed (No). The timestamp signal generation section 510 executes the processing in Step S510-5, thereby being capable of keeping the certain length of the calculation period of the detection frequency of address event detection signals. The processing in Step S510-5 is executed by the register control circuit 512b, for example.

(Step S510-7)

In Step S510-7, the timestamp signal generation section 510 determines whether or not the reciprocal of the detection frequency of address event detection signals calculated in Step S510-3 is smaller than the upper limit value of the currently set timestamp signal temporal resolution (example of predetermined threshold). Here, the upper limit value of the currently set timestamp signal temporal resolution is the value of the timestamp signal temporal resolution set in the register control circuit 512b. That is, the timestamp signal generation section 510 determines whether or not the reciprocal of the detection frequency of address event detection signals calculated in Step S510-3 is smaller than the value of the timestamp signal temporal resolution currently set in the register control circuit 512b. The timestamp signal generation section 510 brings the processing to Step S510-13 in a case where it is determined that the reciprocal of the calculated detection frequency of address event detection signals is smaller than the value of the timestamp signal temporal resolution currently set in the register control circuit 512b and does not exceed the upper limit value of the currently set timestamp signal temporal resolution (predetermined threshold) (Yes). Meanwhile, the timestamp signal generation section 510 brings the processing to Step S510-13 in a case where it is determined that the reciprocal of the calculated detection frequency of address event detection signals is larger than the value of the timestamp signal temporal resolution currently set in the register control circuit 512b and exceeds the upper limit value of the currently set timestamp signal temporal resolution (predetermined threshold) (No). The processing in Step S510-7 is executed by the register control circuit 512b, for example.

(Step S510-9)

In Step S510-9, the timestamp signal generation section 510 determines whether or not the currently set timestamp signal temporal resolution has the maximum value. Here, the maximum value of timestamp signal temporal resolution is the maximum value of the plurality of timestamp signal temporal resolutions stored in the register control circuit 512b. The timestamp signal generation section 510 returns to the processing in Step S510-1 in a case where it is determined that the currently set timestamp signal temporal resolution has the maximum value (Yes). Meanwhile, the timestamp signal generation section 510 transitions to the processing in Step S510-11 in a case where it is determined that the currently set timestamp signal temporal resolution does not have the maximum value (No). In the case where the currently set timestamp signal temporal resolution has the maximum value, the timestamp signal temporal resolution cannot be reduced any further. Thus, even in the case where the reciprocal of the detection frequency of address event detection signals calculated in Step S510-3 is larger than the value of the timestamp signal temporal resolution currently set in the register control circuit 512b (No in Step S510-7), the timestamp signal generation section 510 does not change the timestamp signal temporal resolution and returns to the state of waiting for the input of an address event detection signal (Step S510-1). The processing in Step S510-9 is executed by the register control circuit 512b, for example.

(Step S510-11)

In Step S510-11, the timestamp signal generation section 510 sets the timestamp signal temporal resolution to low resolution and returns to the processing in Step S510-1. More specifically, the timestamp signal generation section 510 changes the timestamp signal temporal resolution currently set in the register control circuit 512b to the one-step-lower temporal resolution. Moreover, the timestamp signal generation section 510 generates an instruction signal including information regarding the changed timestamp signal temporal resolution and instruction information regarding changing the timestamp signal temporal resolution, and outputs the instruction signal to the selection circuit 512a3 (see FIG. 32) of the frequency divider circuit 512a provided in the change section 512. The processing in Step S510-11 is executed by the register control circuit 512b, for example.

When receiving the instruction signal, the selection circuit 512a3 selects a clock signal having a frequency with the same value as the reciprocal of the timestamp signal temporal resolution included in the instruction signal, and outputs the selected clock signal to the counter circuit 513 (see FIG. 32) as a frequency divided clock signal. The counter circuit 513 outputs the one-step-lower resolution timestamp signal to the solid-state imaging element 200.

The processing from Step S510-1 to Step S510-11 is executed to change the timestamp signal output from the timestamp signal generation section 510 as in the period around the time t1 or around the time t2 illustrated in FIG. 34.

(Step S510-13)

In Step S510-13, the timestamp signal generation section 510 determines whether or not the reciprocal of the detection frequency of address event detection signals calculated in Step S510-3 is larger than the lower limit value of the currently set timestamp signal temporal resolution (example of predetermined threshold). Here, the lower limit value of the currently set timestamp signal temporal resolution is a temporal resolution value one step lower than the timestamp signal temporal resolution set in the register control circuit 512b. That is, the timestamp signal generation section 510 determines whether or not the reciprocal of the detection frequency of address event detection signals calculated in Step S510-3 is larger than the value of the temporal resolution one step lower than the timestamp signal temporal resolution currently set in the register control circuit 512b. The timestamp signal generation section 510 returns to the processing in Step S510-1 in a case where it is determined that the reciprocal of the calculated detection frequency of address event detection signals is larger than the value of the temporal resolution one step lower than the timestamp signal temporal resolution currently set in the register control circuit 512b and does not fall below the lower limit value of the currently set timestamp signal temporal resolution (predetermined threshold) (Yes). Meanwhile, the timestamp signal generation section 510 transitions to the processing in Step S510-15 in a case where it is determined that the reciprocal of the calculated detection frequency of address event detection signals is smaller than the value of the temporal resolution one step lower than the timestamp signal temporal resolution currently set in the register control circuit 512b and falls below the lower limit value of the currently set timestamp signal temporal resolution (predetermined threshold) (No). The processing in Step S510-13 is executed by the register control circuit 512b, for example.

(Step S510-15)

In Step S510-15, the timestamp signal generation section 510 determines whether or not the currently set timestamp signal temporal resolution has the minimum value. Here, the minimum value of timestamp signal temporal resolution is the minimum value of the plurality of timestamp signal temporal resolutions stored in the register control circuit 512b. The timestamp signal generation section 510 returns to the processing in Step S510-1 in a case where it is determined that the currently set timestamp signal temporal resolution has the minimum value (Yes). Meanwhile, the timestamp signal generation section 510 transitions to the processing in Step S510-17 in a case where it is determined that the currently set timestamp signal temporal resolution does not have the initial value (No). In the case where the currently set timestamp signal temporal resolution has the initial value, the timestamp signal temporal resolution cannot be increased any further. Thus, even in the case where the reciprocal of the detection frequency of address event detection signals calculated in Step S510-3 is smaller than the value of the temporal resolution one step lower than the timestamp signal temporal resolution currently set in the register control circuit 512b (No in Step S510-13), the timestamp signal generation section 510 does not change the timestamp signal temporal resolution and returns to the state of waiting for the input of an address event detection signal (Step S510-1). The processing in Step S510-15 is executed by the register control circuit 512b, for example.

(Step S510-16)

In Step S510-16, the timestamp signal generation section 510 sets the timestamp signal temporal resolution to high resolution and returns to the processing in Step 3510-1. More specifically, the timestamp signal generation section 510 changes the timestamp signal temporal resolution currently set in the register control circuit 512b to the one-step-higher temporal resolution. Moreover, the timestamp signal generation section 510 generates an instruction signal including information regarding the changed timestamp signal temporal resolution and instruction information regarding changing the timestamp signal temporal resolution, and outputs the instruction signal to the selection circuit 512a3 of the frequency divider circuit 512a provided in the change section 512. The processing in Step S510-16 is executed by the register control circuit 512b, for example.

When receiving the instruction signal, the selection circuit 512a3 selects a clock signal having a frequency with the same value as the reciprocal of the timestamp signal temporal resolution included in the instruction signal, and outputs the selected clock signal to the counter circuit 513 (see FIG. 32) as a frequency divided clock signal. The counter circuit 513 outputs the one-step-higher resolution timestamp signal to the solid-state imaging element 200.

The processing from Step S510-1 to Step S510-7 and Step S510-13 to Step S510-17 is executed to change the temporal resolution of the timestamp signal output from the timestamp signal generation section 510 in the period around the time t1 or around the time t2 illustrated in FIG. 34 in a direction opposite to the time axis illustrated in FIG. 34 (from the right to the left in FIG. 34).

As described above, the event detection device 501 of the present embodiment includes the solid-state imaging element 200 including the plurality of photoelectric conversion elements 333 each configured to perform photoelectric conversion on incident light to generate an electrical signal and the address event detection section 400 configured to output a detection signal indicating the result of detection of whether or not the amount of change in electrical signal of each of the plurality of photoelectric conversion elements 333 exceeds a predetermined threshold, the timestamp signal generation section 510 configured to generate a timestamp signal that is used for indicating a time point at which the address event detection section 400 has detected a detection signal, and the change section 512 provided in the timestamp signal generation section 510 and configured to change the timestamp signal temporal resolution in a case where the detection frequency of address event detection signals exceeds a predetermined threshold.

The event detection device 501 having the above-mentioned configuration can change the timestamp signal temporal resolution according to a moving speed of an object that is an imaging subject. With this, the event detection device 501 can enhance the imaging subject recognition accuracy of the asynchronous solid-state imaging element 200.

Incidentally, in a case where a fixed timestamp signal temporal resolution is used, a device including an asynchronous solid-state imaging element in the related art can sometimes detect, from the moving speed of an object, an edge of the moving object, but sometimes detects an object that may not be the edge of the object. Thus, the related-art device cannot achieve stable recognition accuracy. Further, when a higher timestamp signal temporal resolution is set to detect details of a moving object, detection timings of the plurality of pixel blocks provided in the asynchronous solid-state imaging element vary, so that the device cannot recognize the edge of the moving object or misrecognizes a straight edge of the moving object as a slope edge, resulting in a drop in recognition accuracy, which is a problem. Moreover, in a case where the device is installed on a vehicle, even when optimum timestamp signal temporal resolution is set in the fixed device, the timestamp signal temporal resolution is substantially changed due to a relative velocity between the device and an imaging subject, with the result that the recognition accuracy of the device drops depending on the relative velocity, which is a problem.

In contrast to this, the event detection device 501 of the present embodiment can feed back the detection frequency of event detection signals to change the timestamp signal temporal resolution. Thus, the event detection device 501 can optimize the timestamp signal temporal resolution according to the moving speed of an object that is an imaging subject and the relative velocity between the event detection device 501 and the object. With this, the event detection device 501 can enhance the moving object recognition accuracy.

An address event signal in a period in which the timestamp signal temporal resolution is low resolution is substantially integrated, so that only information sufficient for recognition can be left. Further, in this case, object recognition is facilitated, so that the accuracy of recognizing the movement of an object is enhanced.

Further, when the timestamp signal temporal resolution is set to low resolution, the frequency of a clock signal for generating a timestamp signal (a frequency divided clock signal in the present embodiment) can be reduced. With this, the power consumption of the event detection device 501 can be reduced. Moreover, the event detection device 501 increases or decreases the timestamp signal resolution according to the detection frequency of address event detection signals, thereby being capable of reducing a standby power in waiting time (a period in which almost no address event detection signal is detected).

### 7. Seventh Embodiment

[Configuration Example of Event Detection Device]

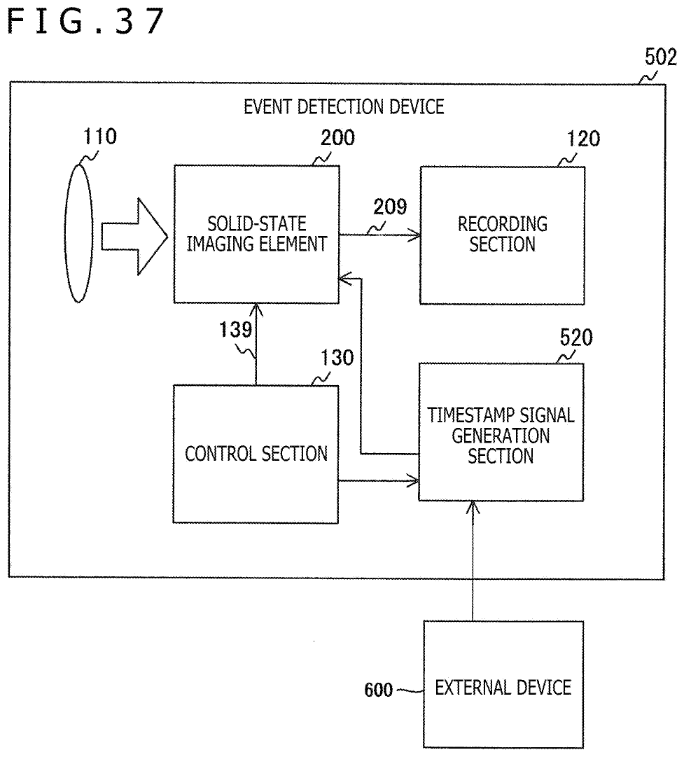

FIG. 37 is a block diagram illustrating a configuration example of an event detection device 502 according to a seventh embodiment of the present technology. The event detection device 502 includes the imaging lens 110 and the solid-state imaging element 200 including the plurality of photoelectric conversion elements 333 (see FIG. 5) each configured to perform photoelectric conversion on incident light to generate an electrical signal and the address event detection section (example of detection section) 400 (see FIG. 3) configured to output a detection signal indicating the result of detection of whether or not the amount of change in electrical signal of each of the plurality of photoelectric conversion elements 333 exceeds a predetermined threshold. Further, the event detection device 502 includes the recording section 120 connected to the solid-state imaging element 200 and the control section 130 configured to control the solid-state imaging element 200. Moreover, the event detection device 502 includes a timestamp signal generation section 520 configured to generate a timestamp signal that is used for indicating a time point at which the address event detection section 400 has detected a detection signal. As the event detection device 502, a camera that is installed on an industrial robot, a vehicle-mounted camera, or the like is assumed.

The imaging lens 110 of the present embodiment is the same as the imaging lens 110 of the sixth embodiment described above in terms of configuration and function. Further, the solid-state imaging element 200 of the present embodiment is the same as the solid-state imaging element 200 of the sixth embodiment described above in terms of configuration and function. The recording section 120 of the present embodiment is the same as the recording section 120 of the sixth embodiment described above in terms of configuration and function. Moreover, the control section 130 of the present embodiment is the same as the control section 130 of the sixth embodiment described above in terms of configuration and function. Thus, the detail descriptions of the imaging lens 110, the solid-state imaging element 200, the recording section 120, and the control section 130 of the present embodiment are omitted.

As illustrated in FIG. 37, an external device 600 is connected to the timestamp signal generation section 520 of the present embodiment. In the case where the event detection device 502 is a camera that is installed on an industrial robot, for example, the external device 600 corresponds to a factory automation control device configured to control the industrial robot, for example. The external device 600 outputs, for example, a change signal for changing a timestamp signal temporal resolution to the timestamp signal generation section 520.

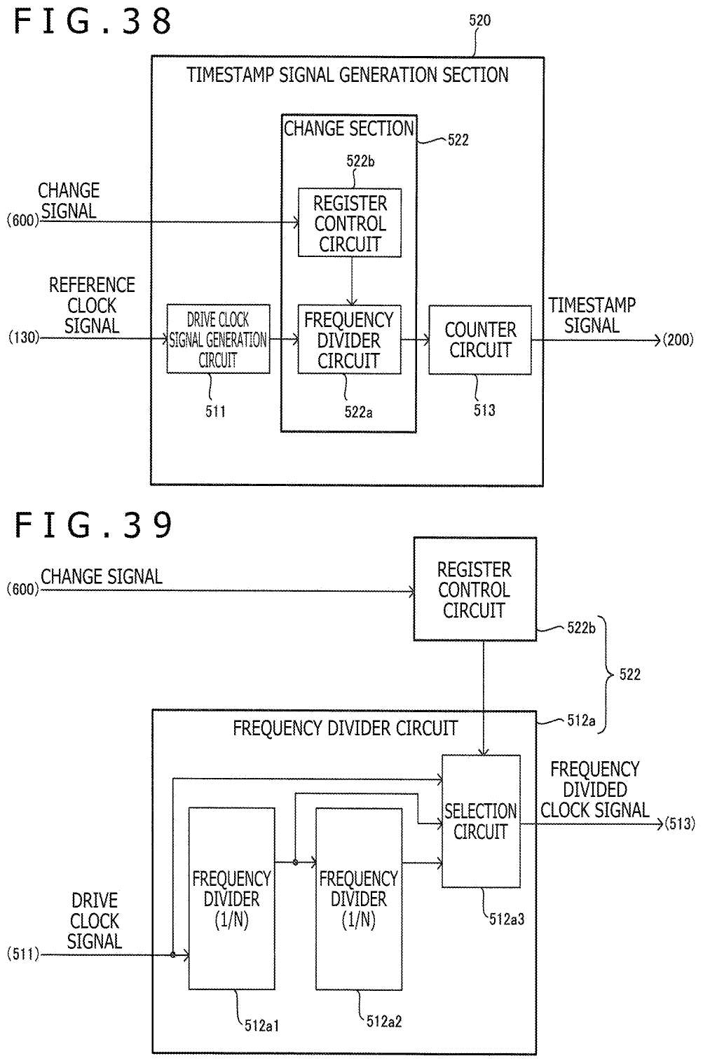

Here, the timestamp signal generation section 520 is described using FIG. 38 to FIG. 41 with reference to FIG. 37. First, the schematic configuration of the timestamp signal generation section 520 is described using FIG. 38 and FIG. 39. FIG. 38 is a block diagram illustrating a configuration example of the timestamp signal generation section 520. FIG. 39 is a block diagram illustrating a configuration example of a change section 522 provided in the timestamp signal generation section 520.

As illustrated in FIG. 38, the timestamp signal generation section 520 includes the drive clock signal generation circuit 511 connected to the control section 130 (see FIG. 31). The drive clock signal generation circuit 511 of the present embodiment is the same as the drive clock signal generation circuit 511 of the sixth embodiment described above in terms of configuration and function. Thus, the description of the drive clock signal generation circuit 511 is omitted.

As illustrated in FIG. 38, the event detection device 502 includes the change section 522 provided in the timestamp signal generation section 520 and configured to change the timestamp signal temporal resolution in a case where a predetermined condition is satisfied. The change section 522 may determine that a predetermined condition for changing the timestamp signal temporal resolution is satisfied in a case where a change signal for changing the timestamp signal temporal resolution (example of predetermined signal) is input from the external device 600 (see FIG. 37).

As illustrated in FIG. 38, the change section 522 includes a register control circuit (example of storage section) 522b configured to store a plurality of timestamp signal temporal resolutions in association with the information included in a change signal input from the external device 600 (example of predetermined condition). The register control circuit 522b can set the currently set timestamp signal temporal resolution. The register control circuit 522b is connected to the external device 600. With this, the register control circuit 522b receives a change signal output from the external device 600. The change signal output from the external device 600 includes information regarding the timestamp signal temporal resolution. The information regarding the timestamp signal temporal resolution may be a numerical value of the temporal resolution or a number associated with the temporal resolution. The register control circuit 522b has, for example, a storage area conforming to a format of the information regarding the timestamp signal temporal resolution included in the change signal. For example, in the case where the information regarding the timestamp signal temporal resolution is a numerical value of the temporal resolution, the storage area of the register control circuit 522b is configured to be capable of storing all the numerical values of the timestamp signal temporal resolution that may possibly be included in the change signal. Further, for example, in the case where the information regarding the timestamp signal temporal resolution is a number associated with the temporal resolution, the storage area of the register control circuit 522b is configured to be capable of storing, as sets, all the numerical values of the timestamp signal temporal resolution that may possibly be included in the change signal and numbers associated with the respective numerical values.

On a factory automation manufacturing line, shapes and sizes of parts to be conveyed, a conveyance speed, and the like are known in advance. That is, in a case where the event detection device 502 is used in factory automation, the shape and size of an object that is captured by the event detection device 502 and the conveyance speed of the object are known in advance. With this, the event detection device 502 can roughly predict a detection time point at which the address event detection section 400 detects an address event. Thus, unlike the event detection device 501 of the sixth embodiment described above, the event detection device 502 of the present embodiment does not feed back the detection frequency of actually detected address event detection signals to change the timestamp signal temporal resolution. The event detection device 502 changes the timestamp signal temporal resolution on the basis of a change signal that includes information regarding an object itself, which is an imaging subject, and the timestamp signal temporal resolution based on the moving speed of the object, and is input from the external device 600.

Further, the external device 600 provided in a moving object whose moving speed changes, such as an automobile, can store in advance information in which the moving speed of the moving object and the timestamp signal temporal resolution are associated with each other. Thus, the event detection device 502 used in the moving object stores, in the register control circuit 522b, the association information stored in the external device 600, thereby being capable of changing the timestamp signal temporal resolution on the basis of the association information included in a change signal input from the external device 600.

In a case where the register control circuit 522b receives a change signal output from the external device 600, the register control circuit 522b analyzes the information regarding the timestamp signal temporal resolution included in the change signal. Further, in a case where it is determined as a result of change signal analysis that the timestamp signal temporal resolution included in the change signal is larger (or smaller) than the currently set timestamp signal temporal resolution, the register control circuit 522b outputs, to a frequency divider circuit 522a, an instruction signal including instruction information regarding changing the timestamp signal temporal resolution to low resolution (or high resolution).

As illustrated in FIG. 38, the change section 522 includes the frequency divider circuit 512a configured to divide the frequency of a drive clock signal (example of clock signal based on reference clock signal). The frequency divider circuit 512a of the present embodiment is the same as the frequency divider circuit 512a of the sixth embodiment described above in terms of configuration and function, and hence the description thereof is omitted.

The timestamp signal generation section 520 includes the counter circuit 513 configured to output, as a timestamp signal, a count value obtained by counting the number of clocks (that is, clock frequency) of a frequency divided clock signal that is a clock signal having a frequency obtained by division by the frequency divider circuit 512a provided in the change section 512. The counter circuit 513 of the present embodiment is the same as the counter circuit 513 of the sixth embodiment described above in terms of configuration and function, and hence the description thereof is omitted.

As illustrated in FIG. 39, the change section 522 is the same as the change section 512 of the sixth embodiment described above in terms of configuration and function except that a change signal is input from the external device 600 to the register control circuit 522b and the register control circuit 522b analyzes the change signal. The register control circuit 522b of the present embodiment has a different configuration from the register control circuit 512b of the sixth embodiment described above, but outputs, to the frequency divider circuit 512a, an instruction signal in the same format as an instruction signal that is output by the register control circuit 512b. Thus, the frequency divider circuit 522a of the present embodiment can have the same configuration as the frequency divider circuit 512a of the sixth embodiment described above.

Note that, also in the present embodiment, the configuration of the frequency divider circuit 512a is not limited to the configuration illustrated in FIG. 39. For example, the number of stages of frequency dividers provided in the frequency divider circuit 512a is not limited to two and may be one or three or more. Further, the frequency divider circuit 512a may include a phase locked loop such that the frequency divider circuit 512a can change the frequency of a drive clock signal by dividing or multiplying the frequency.

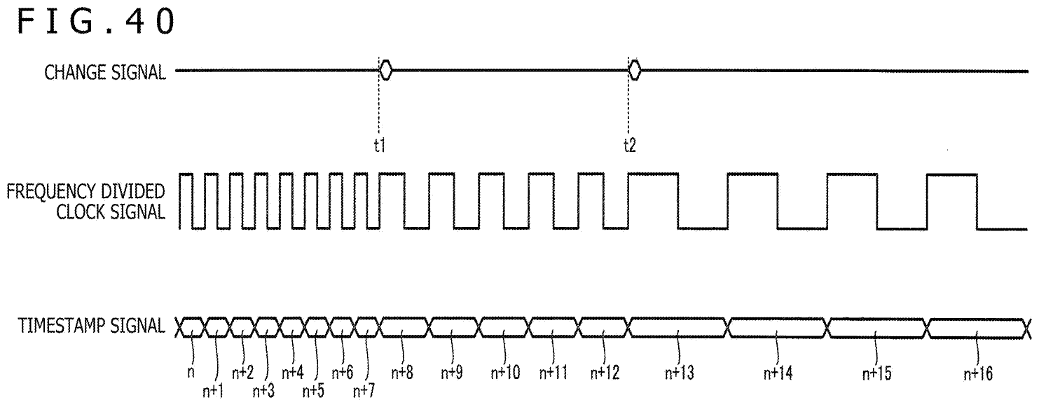

Next, exemplary operation of the timestamp signal generation section 520 is described using FIG. 40 with reference to FIG. 37 to FIG. 39. FIG. 40 is a timing chart illustrating exemplary operation of the timestamp signal generation section 520 included in the event detection device 502 of the present embodiment. “Change signal” illustrated on the first line in FIG. 40 represents a change signal that is output from the external device 600. In FIG. 40, hexagonal frames illustrated on the first line in FIG. 40 represent a change signal output state. “Frequency divided clock signal” illustrated on the second line in FIG. 40 represents a frequency divided clock signal that is input from the change section 512 to the counter circuit 513. “Timestamp signal” illustrated on the third line in FIG. 40 represents a timestamp signal that is output from the timestamp signal generation section 520 to the solid-state imaging element 200. In FIG. 40, the time elapses from the left to the right. Further, to facilitate the understanding, FIG. 40 illustrates a case where the frequency divided clock signal is subjected to ½ frequency division such that the frequency divided clock signal has the same frequency as the drive clock signal until a time t1, the same frequency as a first-stage clock signal in a period of from the time t1 to a time t2, and the same frequency as a second-stage clock signal at and after the time t2.

It is assumed that, in the period until the time t1 illustrated in FIG. 40, an instruction signal that is input from the register control circuit 532b (see FIG. 39) to the selection circuit 512a3 (see FIG. 40) provided in the frequency divider circuit 512a includes a minimum value of the timestamp signal temporal resolution (for example, the same value as the reciprocal of the drive clock signal frequency). With this, the selection circuit 512a3 selects the drive clock signal, thereby outputting a frequency divided clock signal having the same frequency (same period) as the drive clock signal to the counter circuit 513 (see FIG. 38) as illustrated in FIG. 40. Every time the input frequency divided clock signal rises, for example, the counter circuit 513 counts the number of clocks of the frequency divided clock signal and outputs a timestamp signal including the count value to the solid-state imaging element 200 (see FIG. 37). FIG. 40 illustrates count values n to n+7 (n is a natural number) included in the timestamp signal. In the period until the time t1, the frequency of the frequency divided clock signal is, for example, 10 GHz, and the temporal resolution of the timestamp signal is, for example, 100 psec.

At the time t1, when the timestamp signal generation section 520 receives a change signal from the external device 600 (see FIG. 37), the register control circuit 522b analyzes the change signal.

It is assumed that the timestamp signal temporal resolution included in the change signal analyzed by the register control circuit 512b at the time t1 is larger than the currently set timestamp signal temporal resolution (in this example, the same value as the period of the drive clock signal), for example. In this case, the register control circuit 522b outputs, to the selection circuit 512a3, an instruction signal including information regarding the temporal resolution having the same value as the period of the first-stage clock signal and instruction information regarding setting the timestamp signal temporal resolution to low resolution, for example. With this, the selection circuit 512a3 selects the first-stage clock signal, thereby outputting a frequency divided clock signal having the same frequency (same period) as the first-stage clock signal to the counter circuit 513 (see FIG. 38). Thus, as illustrated in FIG. 40, the period of the frequency divided clock signal is long (low frequency) from the time t1. Every time the input frequency divided clock signal rises, for example, the counter circuit 513 counts the number of clocks of the frequency divided clock signal and outputs a timestamp signal including the count value to the solid-state imaging element 200. The counter circuit 513 does not reset the count value even when the period of the frequency divided clock signal is changed. Thus, as illustrated in FIG. 40, around the time t1, the counter circuit 513 outputs, next to the timestamp signal including the count value “n+7,” a timestamp signal including a count value “n+8.” In the period from the time t1 to the time t2, which is described below, the frequency of the frequency divided clock signal is, for example, 100 MHz, and the temporal resolution of the timestamp signal is, for example, 10 nsec.

When the timestamp signal generation section 520 receives a change signal input from the external device 600 (see FIG. 38) at the time t2 that comes after a predetermined time has elapsed from the time t1, the register control circuit 522b analyzes the change signal.

It is assumed that the timestamp signal temporal resolution included in the change signal analyzed by the register control circuit 512b at the time t2 is larger than the currently set timestamp signal temporal resolution (in this example, the same value as the period of the first-stage clock signal), for example. In this case, the register control circuit 522b outputs, to the selection circuit 512a3, an instruction signal including information regarding the temporal resolution having the same value as the period of the second-stage clock signal and instruction information regarding setting the timestamp signal temporal resolution to low resolution, for example. With this, the selection circuit 512a3 selects the second-stage clock signal, thereby outputting a frequency divided clock signal having the same frequency (same period) as the second-stage clock signal to the counter circuit 513. Thus, as illustrated in FIG. 40, the period of the frequency divided clock signal is long (low frequency) from the time t2. Every time the input frequency divided clock signal rises, for example, the counter circuit 513 counts the number of clocks of the frequency divided clock signal and outputs a timestamp signal including the count value to the solid-state imaging element 200. The counter circuit 513 does not reset the count value even when the period of the frequency divided clock signal is changed. Thus, as illustrated in FIG. 34, around the time t2, the counter circuit 513 outputs, next to a timestamp signal including a count value “n+12,” a timestamp signal including a count value “n+13.” At and after the time t3, the frequency of the frequency divided clock signal is, for example, 1 MHz, and the temporal resolution of the timestamp signal is, for example, 1 psec.

FIG. 40 exemplifies the timing chart of the timestamp signal generation section 520 in the case where the timestamp signal temporal resolution is set to low resolution. In a case where the timestamp signal temporal resolution included in a change signal analyzed by the register control circuit 522b is smaller than the currently set timestamp signal temporal resolution, however, the timestamp signal temporal resolution is set to high resolution. As a result, the period of the timestamp signal is short (high frequency).

Next, an event detection method of the present embodiment is described. The event detection method of the present embodiment is the same as the event detection method of the sixth embodiment described above except for requirements for determining the satisfaction of a predetermined condition, and hence the description thereof is omitted. As described above, a case where a predetermined condition is satisfied in the present embodiment is the case where a change signal (example of predetermined signal) for changing the timestamp signal temporal resolution is input from the external device 600 (see FIG. 37).

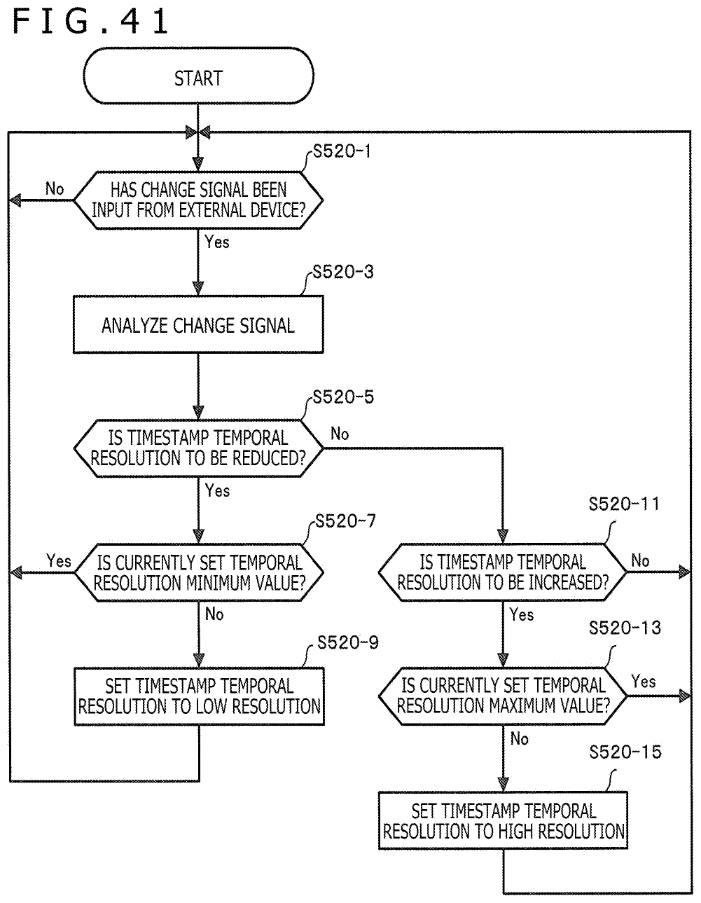

Next, an exemplary flow of the operation of the timestamp signal generation section 520 (timestamp temporal resolution change processing) included in the event detection device 501 of the present embodiment is described using FIG. 41 with reference to FIG. 37 to FIG. 40. FIG. 41 is a flowchart illustrating an exemplary flow of the processing of the timestamp signal generation section 520. When the event detection device 502 (see FIG. 37) is powered on, the timestamp signal generation section 520 starts the processing illustrated in FIG. 41. When the event detection device 502 is powered off, the timestamp signal generation section 520 ends the processing.

(Step S520-1)

As illustrated in FIG. 41, when starting to operate, the timestamp signal generation section 520 (see FIG. 38) first determines whether or not a change signal has been input from the external device 600. The timestamp signal generation section 520 transitions to the processing in Step S520-3 in a case where it is determined that a change signal has been input from the external device 600. Meanwhile, the timestamp signal generation section 520 repeatedly executes the processing in Step S520-1 in a case where it is determined that no change signal has been input from the external device 600. The timestamp signal generation section 520 repeatedly executes, until a change signal is input, the processing in Step S520-1 at time intervals smaller than the minimum value of the timestamp signal temporal resolution.

In this way, the timestamp signal generation section 520 repeatedly executes the processing in Step S520-1 at the time intervals smaller than the minimum value of the timestamp signal temporal resolution, to thereby determine every change signal input from the external device 600 without fail. The processing in Step S520-1 is executed by the register control circuit 522b, for example.

(Step S520-3)

In Step S520-3, the timestamp signal generation section 520 analyzes the change signal input from the external device 600 and transitions to the processing in Step S520-3. The timestamp signal generation section 520 analyzes the change signal input from the external device 600 to acquire the temporal resolution indicated by the information regarding the timestamp signal temporal resolution included in the change signal. The timestamp signal temporal resolution acquired by the timestamp signal generation section 520 may be stored in the register control circuit 522b, for example. Further, the timestamp signal generation section 520 may include, for example, a storage section, which is not illustrated, and may store the timestamp signal temporal resolution acquired by the timestamp signal generation section 520 in the storage section. The processing in Step S520-3 is executed by the register control circuit 522b, for example.

(Step S520-5)

In Step S520-5, the timestamp signal generation section 520 compares the timestamp signal temporal resolution acquired in Step S520-3 and the currently set timestamp signal temporal resolution to each other, to thereby determine whether or not to reduce the timestamp signal temporal resolution. The timestamp signal generation section 520 transitions to the processing in Step S520-7 in a case where it is determined that there is a need to reduce the timestamp signal temporal resolution (Yes). Meanwhile, the timestamp signal generation section 520 transitions to the processing in Step 3520-11 in a case where it is determined that there is no need to reduce the timestamp signal temporal resolution (No).

(Step S520-7)

In Step S520-7, the timestamp signal generation section 520 determines whether or not the currently set timestamp signal temporal resolution has the maximum value. Here, the maximum value of the timestamp signal temporal resolution is the maximum value of the plurality of timestamp signal temporal resolutions stored in the register control circuit 522b. The timestamp signal generation section 520 returns to the processing in Step S520-1 in a case where it is determined that the currently set timestamp signal temporal resolution has the maximum value (Yes). Meanwhile, the timestamp signal generation section 520 transitions to the processing in Step S520-9 in a case where it is determined that the currently set timestamp signal temporal resolution does not have the maximum value (No). In the case where the currently set timestamp signal temporal resolution has the maximum value, the timestamp signal temporal resolution cannot be reduced any further. Thus, even in the case where the timestamp signal temporal resolution acquired by the analysis in Step S520-3 is larger than the value of the timestamp signal temporal resolution currently set in the register control circuit 522b, the timestamp signal generation section 520 does not change the timestamp signal temporal resolution and returns to the state of waiting for the input of an address event detection signal (Step S520-1). The processing in Step S520-7 is executed by the register control circuit 522b, for example.

(Step S520-9)

In Step S520-9, the timestamp signal generation section 520 sets the timestamp signal temporal resolution to low resolution and returns to the processing in Step S520-1. More specifically, the timestamp signal generation section 520 changes the timestamp signal temporal resolution currently set in the register control circuit 522b to the one-step-lower temporal resolution. Moreover, the timestamp signal generation section 520 generates an instruction signal including information regarding the changed timestamp signal temporal resolution and instruction information regarding changing the timestamp signal temporal resolution, and outputs the instruction signal to the selection circuit 512a3 (see FIG. 39) of the frequency divider circuit 512a. The processing in Step S520-11 is executed by the register control circuit 522b, for example.

When receiving the instruction signal, the selection circuit 512a3 selects a clock signal having a frequency with the same value as the reciprocal of the timestamp signal temporal resolution included in the instruction signal, and outputs the selected clock signal to the counter circuit 513 as a frequency divided clock signal. The counter circuit 513 outputs the one-step-lower resolution timestamp signal to the solid-state imaging element 200.

The processing from Step S520-1 to Step S520-9 is executed to change the timestamp signal output from the timestamp signal generation section 520 as in the period around the time t1 or around the time t2 illustrated in FIG. 40.

(Step S520-11)

In Step S520-11, the timestamp signal generation section 520 compares the timestamp signal temporal resolution acquired in Step S520-3 and the currently set timestamp signal temporal resolution to each other, to thereby determine whether or not to increase the timestamp signal temporal resolution. The timestamp signal generation section 520 transitions to the processing in Step S520-13 in a case where it is determined that there is a need to increase the timestamp signal temporal resolution (Yes). Meanwhile, the timestamp signal generation section 520 returns to the processing in Step S520-1 in a case where it is determined that there is no need to increase the timestamp signal temporal resolution (No).

(Step S510-15)

In Step S510-15, the timestamp signal generation section 520 determines whether or not the currently set timestamp signal temporal resolution has the maximum value. Here, the maximum value of timestamp signal temporal resolution is the maximum value of the plurality of timestamp signal temporal resolutions stored in the register control circuit 522b. The timestamp signal generation section 520 returns to the processing in Step S520-1 in a case where it is determined that the currently set timestamp signal temporal resolution has the maximum value (Yes). Meanwhile, the timestamp signal generation section 520 transitions to the processing in Step S520-15 in a case where it is determined that the currently set timestamp signal temporal resolution does not have the maximum value (No). In the case where the currently set timestamp signal temporal resolution has the maximum value, the timestamp signal temporal resolution cannot be increased any further. Thus, even in the case where the timestamp signal temporal resolution acquired in Step S520-3 is smaller than the value of the temporal resolution one step lower than the timestamp signal temporal resolution currently set in the register control circuit 522b (No in Step S520-13), the timestamp signal generation section 520 does not change the timestamp signal temporal resolution and returns to the state of waiting for the input of a change signal from the external device 600 (Step S520-1). The processing in Step S520-13 is executed by the register control circuit 522b, for example.

(Step S520-15)

In Step S520-15, the timestamp signal generation section 520 sets the timestamp signal temporal resolution to high resolution and returns to the processing in Step S520-1. More specifically, the timestamp signal generation section 520 changes the timestamp signal temporal resolution currently set in the register control circuit 522b to the one-step-higher temporal resolution. Moreover, the timestamp signal generation section 520 generates an instruction signal including information regarding the changed timestamp signal temporal resolution and instruction information regarding changing the timestamp signal temporal resolution, and outputs the instruction signal to the selection circuit 512a3 of the frequency divider circuit 512a. The processing in Step S520-15 is executed by the register control circuit 522b, for example.

When receiving the instruction signal, the selection circuit 512a3 selects a clock signal having a frequency with the same value as the reciprocal of the timestamp signal temporal resolution included in the instruction signal, and outputs the selected clock signal to the counter circuit 513 as a frequency divided clock signal. The counter circuit 513 outputs the one-step-higher resolution timestamp signal to the solid-state imaging element 200.

The processing from Step S510-1 to Step S510-5 and Step S11 to Step S520-11 is executed to change the temporal resolution of the timestamp signal output from the timestamp signal generation section 520 in the period around the time t1 or around the time t2 illustrated in FIG. 40 in a direction opposite to the time axis illustrated in FIG. 40 (from the right to the left in FIG. 40).

As described above, the event detection device 502 of the present embodiment includes the solid-state imaging element 200 including the plurality of photoelectric conversion elements 333 each configured to perform photoelectric conversion on incident light to generate an electrical signal and the address event detection section 400 configured to output a detection signal indicating the result of detection of whether or not the amount of change in electrical signal of each of the plurality of photoelectric conversion elements 333 exceeds a predetermined threshold, the timestamp signal generation section 510 configured to generate a timestamp signal that is used for indicating a time point at which the address event detection section 400 has detected a detection signal, and the change section 522 provided in the timestamp signal generation section 520 and configured to change the timestamp signal temporal resolution in a case where the detection frequency of address event detection signals exceeds a predetermined threshold.

The event detection device 502 having the above-mentioned configuration can change the timestamp signal temporal resolution according to the moving speed of an object that is an imaging subject. With this, the event detection device 501 can obtain effects similar to those of the event detection device 501 according to the sixth embodiment described above.

### 8. Eighth Embodiment

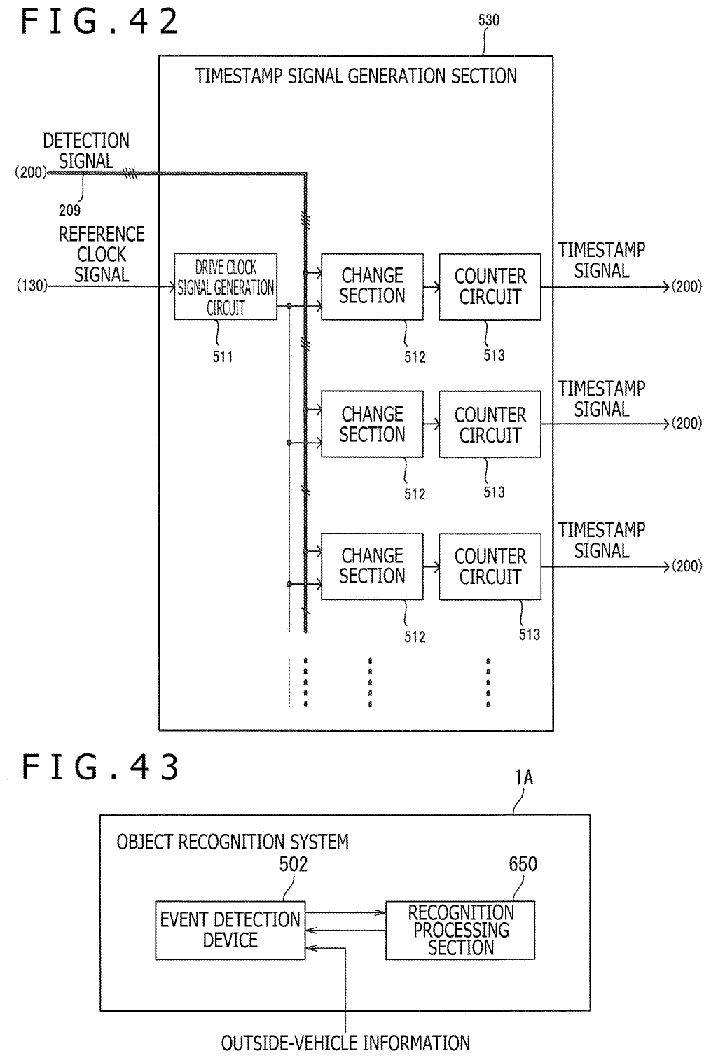

An event detection device according to an eighth embodiment of the present technology is described with reference to FIG. 42. The event detection device of the present embodiment has a similar configuration to the event detection device 501 of the sixth embodiment described above except for the configuration of the timestamp signal generation section. Thus, the components of the event detection device of the present embodiment that have similar actions or functions to those of the event detection device 501 of the sixth embodiment described above are denoted by the same reference signs, and the descriptions thereof are omitted. FIG. 42 is a block diagram illustrating a schematic configuration of a timestamp signal generation section 530 included in the event detection device of the present embodiment.

As illustrated in FIG. 42, the timestamp signal generation section 530 includes the single drive clock signal generation circuit 511, the plurality of change sections 512 each connected to the drive clock signal generation circuit 511, and the plurality of counter circuits 513 connected to the plurality of change sections 512 on a one-to-one basis. The number of the counter circuits 513 and the number of the change sections 512 are the same.

The solid-state imaging element 200 (see FIG. 31) included in the event detection device of the present embodiment includes the plurality of pixel blocks 310 (see FIG. 4) each including a predetermined number of the plurality of photoelectric conversion elements 333 (see FIG. 5). Further, the address event detection section (example of detection section) 400 is provided each for the plurality of pixel blocks 310. Moreover, the change section 512 is provided each for a plurality of address event detection sections 400. The plurality of pixel blocks 310 is arrayed in n rows and m columns (n and m are natural numbers) in the pixel array section 300 (see FIG. 4), for example. In the present embodiment, the change section 512 is provided in each column of the pixel blocks 310, for example. Thus, the timestamp signal generation section 530 includes the m change sections 512. The m change sections 512 are each connected to the n address event detection sections 400.

The change section 512 changes, on the basis of the detection frequencies of detection signals of the respective n address event detection sections 400 connected thereto through the signal line 209, the frequency of a frequency division counter signal to be output to the counter circuit 513. More specifically, the change section 512 determines a timestamp signal temporal resolution on the basis of an average value of the detection frequencies of address event detection signals of the respective n address event detection sections 400 in a calculation target period, for example. Note that the change section 512 may determine the timestamp signal temporal resolution on the basis of the maximum or minimum value or another representative value of the detection frequencies of address event detection signals.

As described above, the event detection device of the present embodiment includes the change section 512 having a similar configuration to the change section 512 provided in the event detection device 501 of the sixth embodiment described above. With this, the event detection device of the present embodiment can obtain effects similar to those of the event detection device 501 of the sixth embodiment described above.

Further, the event detection device of the present embodiment includes the plurality of change sections 512 each of which is provided for the plurality of address event detection sections 400 (each column of the pixel blocks 310 in the present embodiment). Thus, the event detection device of the present embodiment can change the timestamp signal temporal resolution in each predetermined region of the pixel array section 300 (the region corresponding to one column of the pixel blocks 310 in the present embodiment). With this, the event detection device of the present embodiment can enhance the imaging subject recognition accuracy in each predetermined region of the pixel array section 300.

### 9. Ninth Embodiment

A system according to a ninth embodiment of the present technology is described with reference to FIG. 43. The system of the present embodiment can be, for example, an imaging system or an object recognition system and can be installed on a mobile body to be used. Now, the system of the present embodiment is described by taking an object recognition system as an example. FIG. 43 is a block diagram illustrating a configuration example of an object recognition system (example of system) 1A of the present embodiment.

As illustrated in FIG. 43, the object recognition system 1A includes a recognition processing section 650 configured to recognize a predetermined object and the event detection device 502. The event detection device 502 is similar to the event detection device 502 of the seventh embodiment described above in terms of configuration and function except for receiving outside-vehicle information. That is, the event detection device 502 includes the solid-state imaging element 200 (see FIG. 37) including the plurality of photoelectric conversion elements 333 (see FIG. 5) each configured to perform photoelectric conversion on incident light to generate an electrical signal and the event detection section (example of detection section) 400 configured to output a detection signal indicating the result of detection of whether or not the amount of change in electrical signal of each of the plurality of photoelectric conversion elements 333 exceeds a predetermined threshold. Further, the event detection device 502 includes the timestamp signal generation section 520 (see FIG. 37) configured to generate a timestamp signal that is used for indicating a time point at which the event detection section 400 has detected a detection signal, and the change section 522 (see FIG. 38) provided in the timestamp signal generation section 520 and configured to change the timestamp signal temporal resolution in a case where a predetermined condition is satisfied.

The control section 130 (see FIG. 37) provided in the event detection device 502 receives outside-vehicle information. The control section 130 operates on the basis of outside-vehicle information. For example, the control section 130 may raise a detection threshold of the event detection section when the outside-vehicle information is information indicating a bad weather, or may lower the detection threshold of the event detection section or return the detection threshold to an initial setting value when receiving outside-vehicle information indicating that the weather gets better or is good.

As illustrated in FIG. 43, the event detection device 502 and the recognition processing section 650 are connected to each other. The recognition processing section 650 recognizes an object in an angle of field of the event detection device 502 on the basis of an address event detection signal and imaging data input from the event detection device 502. The recognition processing section 650 performs object recognition for recognizing, for example, a vehicle or human (example of predetermined object). In object recognition, the recognition processing section 60 can use a well-known pattern recognition technology, for example, a technology that compares feature points of an image given as training data and feature points of a captured object image to each other to perform image recognition.

The recognition processing section 650 stores an object to be recognized and information regarding a timestamp signal temporal resolution in association with each other. The recognition processing section 650 outputs a change signal including information regarding the timestamp signal temporal resolution associated with a successfully recognized object to the event detection device 502.

The register control circuit 524 provided in the event detection device 502 has stored therein information corresponding to an object to be recognized and information regarding the timestamp signal temporal resolution stored in the recognition processing section 650 in association with each other. Thus, when receiving a change signal from the recognition processing section 650, the change section 522 provided in the event detection device 502 analyzes the change signal to acquire information regarding the timestamp signal temporal resolution from the change signal. The event detection device 502 can change, by processing similar to that of the event detection device 502 of the seventh embodiment described above, the timestamp signal temporal resolution on the basis of the acquired information regarding the timestamp signal temporal resolution. In this way, the change section 522 provided in the event detection device 502 determines that a predetermined condition is satisfied in a case where the recognition processing section 650 has succeeded in object recognition.

As described above, the object recognition system 1A of the present embodiment includes the recognition processing section 650 configured to recognize a predetermined object, and the event detection device 502 configured to change the timestamp signal temporal resolution in a case where it is determined that the recognition processing section 650 has succeeded in object recognition. With this, the object recognition system 1A can change the timestamp signal temporal resolution according to a recognized object and thus obtain effects similar to those of the seventh embodiment described above.

### 10. Tenth Embodiment

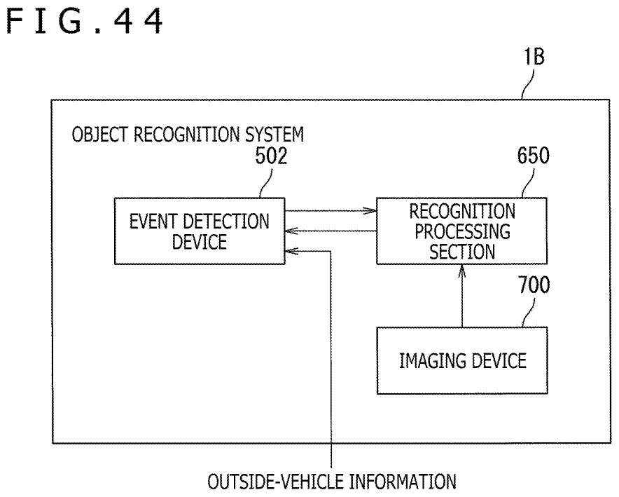

A system according to a tenth embodiment of the present technology is described with reference to FIG. 44. The system of the present embodiment can be, for example, an imaging system or an object recognition system and can be installed on a mobile body to be used as in the ninth embodiment described above. Now, the system of the present embodiment is described by taking an object recognition system as an example. FIG. 44 is a block diagram illustrating a configuration example of an object recognition system (example of system) 1B of the present embodiment.

As illustrated in FIG. 44, the object recognition system 1B includes the recognition processing section 650 configured to recognize a predetermined object, the event detection device 502, and an imaging device 700 connected to the recognition processing section 650. The event detection device 502 is the same as the event detection device 502 of the ninth embodiment described above in terms of configuration and function. The recognition processing section 650 is similar to the recognition processing section 650 of the ninth embodiment described above in terms of configuration and function except for receiving data captured by the imaging device 700.

As the imaging device 700, there can be used a synchronous imaging device configured to perform imaging at a fixed frame rate in synchronization with a vertical synchronization signal and output frame format image data. Examples of the synchronous imaging device can include CMOS (Complementary Metal Oxide Semiconductor) image sensors and CCD (Charge Coupled Device) image sensors.

A fixed-frame-rate asynchronous imaging device is an imaging device configured to detect an event in asynchronization with a vertical synchronization signal while a synchronous imaging device performs imaging in synchronization with a vertical synchronization signal. An event detection device including an asynchronous imaging device has a pixel configuration including an event detection section. Thus, the event detection device is inevitably larger in pixel size than a synchronous imaging device, and is thus low in resolution as compared to an imaging device configured to perform imaging at a fixed frame rate. The object recognition system 1B of the present embodiment includes the synchronous imaging device 700. Thus, the imaging device 700 is better in resolution than an asynchronous imaging device.

The imaging device 700 outputs imaging data to the recognition processing section 650. The recognition processing section 650 can perform object recognition using the high-resolution imaging data input from the imaging device 700. With this, the object recognition accuracy of the recognition processing section 650 of the present embodiment is enhanced as compared to that of the recognition processing section 650 of the ninth embodiment described above.

The recognition processing section 650 of the present embodiment executes object recognition by processing similar to that of the recognition processing section 650 of the ninth embodiment described above. In the case of having succeeded in object recognition, the recognition processing section 650 outputs a change signal including information regarding the timestamp signal temporal resolution associated with the successfully recognized object to the event detection device 502. When receiving the change signal, the event detection device 502 of the present embodiment changes the timestamp signal temporal resolution by processing similar to that of the event detection device 502 of the ninth embodiment described above.

As described above, the object recognition system 1B of the present embodiment includes the recognition processing section 650 configured to recognize a predetermined object, and the event detection device 502 configured to change the timestamp signal temporal resolution in a case where it is determined that the recognition processing section 650 has succeeded in object recognition. With this, the object recognition system 1B can obtain effects similar to those of the ninth embodiment described above.

Moreover, the object recognition system 1B of the present embodiment includes the imaging device 700 connected to the recognition processing section 650. With this, the object recognition accuracy of the recognition processing section 650 of the object recognition system 1B can be enhanced.

<11. Application Example to Mobile Body>

The technology according to the present disclosure (present technology) is applicable to various products. For example, the technology according to the present disclosure may be realized as a device that is installed on any kind of mobile bodies, for example, vehicles, electric vehicles, hybrid electric vehicles, motorcycles, bicycles, personal mobilities, airplanes, drones, ships, and robots.

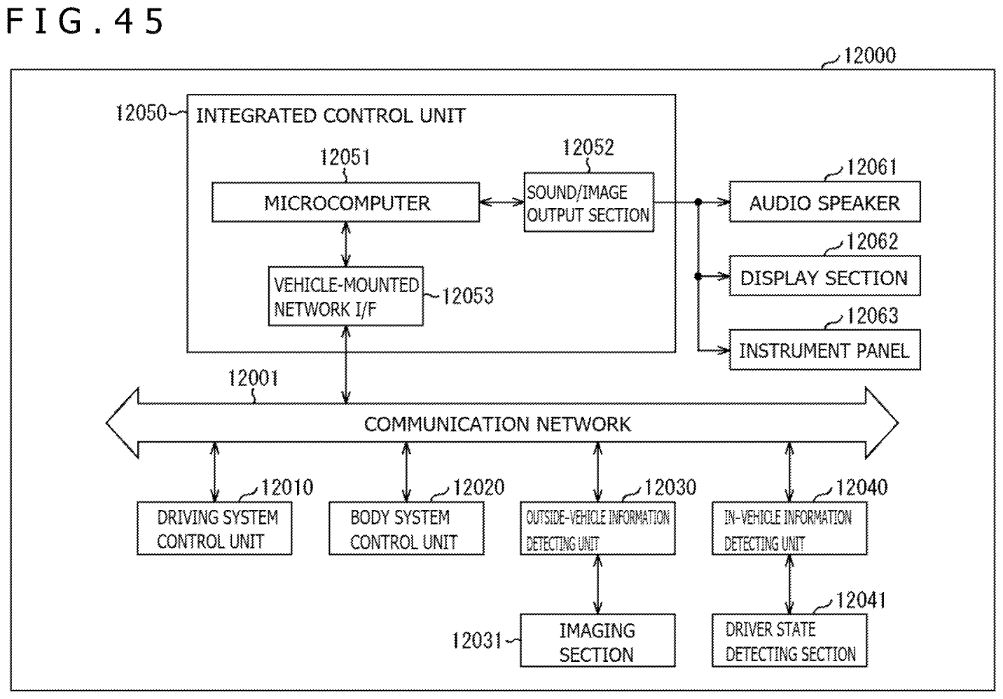

FIG. 45 is a block diagram depicting an example of schematic configuration of a vehicle control system as an example of a mobile body control system to which the technology according to an embodiment of the present disclosure can be applied.

The vehicle control system 12000 includes a plurality of electronic control units connected to each other via a communication network 12001. In the example depicted in FIG. 28, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automatic driving, which makes the vehicle to travel autonomously without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example of FIG. 45, an audio speaker 12061, a display section 12062, and an instrument panel 12063 are illustrated as the output device. The display section 12062 may, for example, include at least one of an on-board display and a head-up display.

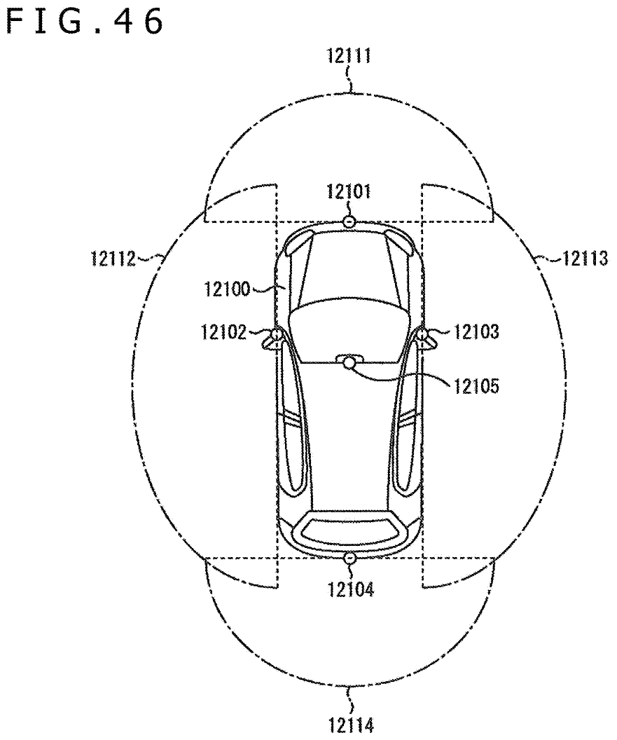

FIG. 46 is a diagram depicting an example of the installation position of the imaging section 12031.

In FIG. 46, the imaging section 12031 includes imaging sections 12101, 12102, 12103, 12104, and 12105.

The imaging sections 12101, 12102, 12103, 12104, and 12105 are, for example, disposed at positions on a front nose, sideview mirrors, a rear bumper, and a back door of the vehicle 12100 as well as a position on an upper portion of a windshield within the interior of the vehicle. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Incidentally, FIG. 46 depicts an example of photographing ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automatic driving that makes the vehicle travel autonomously without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 121104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

An exemplary vehicle control system to which the technology according to the present disclosure is applicable has been described above. The technology according to the present disclosure is applicable to the imaging section 12031 among the above-mentioned configurations, for example. Specifically, the imaging device 100 of FIG. 1 is applicable to the imaging section 12031. Applying the technology according to the present disclosure to the imaging section 12031 can reduce a circuit mounting area, to thereby downsize the imaging section 12031.

Note that the above-mentioned embodiments are examples for implementing the present technology, and the matters in the embodiments have correspondence relations with matters to define the invention in the scope of claims. In a similar manner, the matters to define the invention in the scope of claims have correspondence relations with the matters in the embodiments of the present technology denoted by the same names. However, the present technology is not limited to the embodiments, and various modifications of the embodiments can be implemented without departing from the gist of the present technology.

Further, the processing procedures described in the above-mentioned embodiments may be regarded as a method including the series of procedures, or as a program for causing a computer to execute the series of procedures or a recording medium having stored therein the program. Examples of the recording medium can include CDs (Compact Discs), MDs (Mini Discs), DVDs (Digital Versatile Discs), memory cards, and Blu-ray (registered trademark) Discs.

The present technology is not limited to the first to eighth embodiments described above, and various modifications can be made.

The event detection device 501 of the sixth embodiment described above calculates the detection frequency of address event detection signals on the basis of the number of address event detection signals detected in a calculation target period, but the present technology is not limited thereto. For example, the event detection device 501 may use a detection interval of address event detection signals as the detection frequency of address event detection signals. The event detection device 501 may change the timestamp signal temporal resolution in a case where the detection interval of address event detection signals in the same light-receiving section 330 exceeds a predetermined threshold (lower or upper limit value of detection interval). The detection interval of address event detection signals that is compared to the predetermined threshold may be a representative value (average value, minimum value, maximum value, or the like) of the detection intervals of all the light-receiving sections 330 provided in the pixel array section 300. Further, in the case where the event detection device includes a plurality of change sections as in the eighth embodiment described above, the detection interval of address event detection signals that is compared to the predetermined threshold may be a representative value (average value, minimum value, maximum value, or the like) of the detection intervals of a plurality of light-receiving sections connected to the plurality of change sections.

In addition, in this case, the event detection device 501 may provide a calculation target period for the detection interval of address event detection signals and change the timestamp signal temporal resolution on the basis of a representative value (average value, minimum value, maximum value, or the like) of the detection intervals of address event detection signals in the period. In this way, with a calculation target period for the detection interval of address event detection signals, the timestamp signal temporal resolution can be prevented from being repeatedly changed in a short cycle due to a particular region in which only the light-receiving section 330 in a predetermined region repeats receiving light and stopping receiving light in a short cycle.

The change section 512 of the sixth embodiment described above changes the timestamp signal temporal resolution according to the detection frequency of address event detection signals, and the change section 522 of the seventh embodiment described above changes the timestamp signal temporal resolution on the basis of a change signal input from the external device 600, but the present technology is not limited thereto. For example, the change section provided in the event detection device may change the timestamp signal temporal resolution on the basis of either one of or both the detection frequency of address event detection signals and a change signal input from the external device, appropriately. With this, the event detection device can achieve more various moving object detection methods.

The event detection device 502 of the seventh embodiment described above may be connected to the recognition processing section 650 instead of the external device 600. In this case, the register control circuit 522 preferably stores information corresponding to an object to be recognized and information regarding the timestamp signal temporal resolution stored in the recognition processing section 650 in association with each other. With this, the change section 522 can change the timestamp signal temporal resolution on the basis of the result of analysis of a change signal input in a case where the recognition processing section 650 has succeeded in object recognition. In this case, the change section 522 determines that a predetermined condition is satisfied in a case where the recognition processing section 650 has succeeded in object recognition.

Note that the effects described herein are only exemplary and not limitative, and other effects may be provided.

Note that the present technology can also take the following configurations.

(1) An event detection device including:

a solid-state imaging element including
a plurality of photoelectric conversion elements each configured to perform photoelectric conversion on incident light to generate an electrical signal, and
a detection section configured to output a detection signal indicating a result of detection of whether or not an amount of change in the electrical signal of each of the plurality of photoelectric conversion elements exceeds a predetermined threshold;

a timestamp signal generation section configured to generate a timestamp signal that is used for indicating a time point at which the detection section has detected the detection signal; and

a change section provided in the timestamp signal generation section and configured to change a temporal resolution of the timestamp signal in a case where a predetermined condition is satisfied.

(2) The event detection device according to Item (1), in which the change section includes a storage section configured to store a plurality of the temporal resolutions in association with the predetermined condition.

(3) The event detection device according to Item (2),

in which the change section includes a frequency divider circuit configured to divide a frequency of a clock signal based on a reference clock signal, and

the frequency divider circuit changes the number of times of frequency division, based on information regarding the temporal resolution input from the storage section.

(4) The event detection device according to Item (3), in which the timestamp signal generation section includes a counter circuit configured to output, as the timestamp signal, a count value obtained by counting a frequency of a frequency divided clock signal that is a clock signal having a frequency obtained by division by the frequency divider circuit.

(5) The event detection device according to any one of Items (1) to (4),

in which the solid-state imaging element includes a plurality of pixel blocks each including a predetermined number of the plurality of photoelectric conversion elements,

the detection section is provided each for the plurality of pixel blocks, and

the change section is provided each for a plurality of the detection sections.

(6) The event detection device according to any one of Items (1) to (5), in which the change section determines that the predetermined condition is satisfied in a case where a detection frequency of the detection signal exceeds a predetermined threshold.

(7) The event detection device according to any one of Items (1) to (6), in which the change section determines that the predetermined condition is satisfied in a case where a predetermined signal is input from an external device.

(8) The event detection device according to any one of Items (1) to (6), in which the change section determines that the predetermined condition is satisfied in a case where a recognition processing section configured to recognize a predetermined object has succeeded in object recognition.

(9) A system including:

a recognition processing section configured to recognize a predetermined object; and

an event detection device including
a solid-state imaging element including
   a plurality of photoelectric conversion elements each configured to perform photoelectric conversion on incident light to generate an electrical signal, and
   a detection section configured to output a detection signal indicating a result of detection of whether or not an amount of change in the electrical signal of each of the plurality of photoelectric conversion elements exceeds a predetermined threshold,
a timestamp signal generation section configured to generate a timestamp signal that is used for indicating a time point at which the detection section has detected the detection signal, and
a change section provided in the timestamp signal generation section and configured to change a temporal resolution of the timestamp signal in a case where a predetermined condition is satisfied,

in which the change section determines that the predetermined condition is satisfied in a case where the recognition processing section has succeeded in object recognition.

(10) The system according to Item (9), further including:

an imaging device connected to the recognition processing section.

(11) An event detection method including:

performing, by a photoelectric conversion element, photoelectric conversion on incident light to generate an electrical signal;

detecting, by a detection section, whether or not an amount of change in the electrical signal exceeds a predetermined threshold and outputting a detection signal;

generating, by a timestamp signal generation section, a timestamp signal that is used for indicating a time point at which the detection signal has been detected; and

changing, by a change section provided in the timestamp signal generation section, a temporal resolution of the timestamp signal in a case where a predetermined condition is satisfied.

### REFERENCE SIGNS LIST

100, 700: Imaging device
110: Imaging lens
120: Recording section
130: Control section
200: Solid-state imaging element
201: Light-receiving chip
202: Detection chip
211: Drive circuit
212: Signal processing section
213: Arbiter
220: Column ADC
230: ADC
240: Differential amplifier circuit
241, 242, 412: P-type transistor
243, 244, 245, 411, 413: N-type transistor
250: Counter
300: Pixel array section
310: Pixel block
311: Pixel
312: Normal pixel
313: Address event detection pixel
320: Pixel signal generation section
321: Reset transistor
322: Amplifier transistor
323: Select transistor
324: Floating diffusion layer
330: Light-receiving section
331: Transfer transistor
332: OFG transistor
333: Photoelectric conversion element
400: Address event detection section
410: Current-voltage conversion section
420: Buffer
430: Subtractor
431, 433: Capacitor
432: Inverter
434: Switch
440: Quantizer
441: Comparator
450: Transfer section
501, 502: Event detection device
510, 520: Timestamp signal generation section
511: Drive clock signal generation circuit
512, 522: Change section
512a: Frequency divider circuit
512a1: First-stage frequency divider
512a2: Second-stage frequency divider
512a3: Selection circuit
512b, 522b: Register control circuit
513: Counter circuit
600: External device
12031: Imaging section

1. An event detection device comprising:
a solid-state imaging element including
a plurality of photoelectric conversion elements each configured to perform photoelectric conversion on incident light to generate an electrical signal, and
a detection section configured to output a detection signal indicating a result of detection of whether or not an amount of change in the electrical signal of each of the plurality of photoelectric conversion elements exceeds a predetermined threshold;
a timestamp signal generation section configured to generate a timestamp signal that is used for indicating a time point at which the detection section has detected the detection signal; and
a change section provided in the timestamp signal generation section and configured to change a temporal resolution of the timestamp signal in a case where a predetermined condition is satisfied.

2. The event detection device according to claim 1, wherein the change section includes a storage section configured to store a plurality of the temporal resolutions in association with the predetermined condition.

3. The event detection device according to claim 2,
wherein the change section includes a frequency divider circuit configured to divide a frequency of a clock signal based on a reference clock signal, and
the frequency divider circuit changes the number of times of frequency division, based on information regarding the temporal resolution input from the storage section.

4. The event detection device according to claim 3, wherein the timestamp signal generation section includes a counter circuit configured to output, as the timestamp signal, a count value obtained by counting a frequency of a frequency divided clock signal that is a clock signal having a frequency obtained by division by the frequency divider circuit.

5. The event detection device according to claim 1,
wherein the solid-state imaging element includes a plurality of pixel blocks each including a predetermined number of the plurality of photoelectric conversion elements,
the detection section is provided each for the plurality of pixel blocks, and
the change section is provided each for a plurality of the detection sections.

6. The event detection device according to claim 1, wherein the change section determines that the predetermined condition is satisfied in a case where a detection frequency of the detection signal exceeds a predetermined threshold.

7. The event detection device according to claim 1, wherein the change section determines that the predetermined condition is satisfied in a case where a predetermined signal is input from an external device.

8. The event detection device according to claim 1, wherein the change section determines that the predetermined condition is satisfied in a case where a recognition processing section configured to recognize a predetermined object has succeeded in object recognition.

9. A system comprising:
a recognition processing section configured to recognize a predetermined object; and
an event detection device including
a solid-state imaging element including
a plurality of photoelectric conversion elements each configured to perform photoelectric conversion on incident light to generate an electrical signal, and
a detection section configured to output a detection signal indicating a result of detection of whether or not an amount of change in the electrical signal of each of the plurality of photoelectric conversion elements exceeds a predetermined threshold,
a timestamp signal generation section configured to generate a timestamp signal that is used for indicating a time point at which the detection section has detected the detection signal, and
a change section provided in the timestamp signal generation section and configured to change a temporal resolution of the timestamp signal in a case where a predetermined condition is satisfied,
wherein the change section determines that the predetermined condition is satisfied in a case where the recognition processing section has succeeded in object recognition.

10. The system according to claim 9, further comprising:
an imaging device connected to the recognition processing section.

11. An event detection method comprising:
performing, by a photoelectric conversion element, photoelectric conversion on incident light to generate an electrical signal;
detecting, by a detection section, whether or not an amount of change in the electrical signal exceeds a predetermined threshold and outputting a detection signal;
generating, by a timestamp signal generation section, a timestamp signal that is used for indicating a time point at which the detection signal has been detected; and
changing, by a change section provided in the timestamp signal generation section, a temporal resolution of the timestamp signal in a case where a predetermined condition is satisfied.
